(19) United States
(12) Patent Application Publication
(10) Pub. No.: US 2009/0184292 A1
(43) Pub. Date: Jul. 23, 2009

(54) POLYMER COMPOUND AND POLYMER LIGHT EMITTING DEVICE

(75) Inventors: Kazuei Ohuchi, Ibaraki (JP); Yasunori Uetani, Ibaraki (JP); Akiko Nakazono, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/302,036

(22) PCT Filed: May 30, 2007
(86) PCT No.: PCT/JP07/61407

§ 371 Date: Dec. 3, 2008

(30) Foreign Application Priority Data
May 31, 2006 (JP) 2006-151274

(51) Int. Cl. C09K 11/06; C08F 26/06

(52) U.S. Cl. 252/301.35; 526/259

(57) ABSTRACT

A polymer compound having a conjugated polymer main chain and at least one side chain selected from the following (a), (b) and (c):
(a) side chain having electron transportability, wherein the value of LUMO energy of the side chain and the value of LUMO energy of the conjugated polymer main chain are mutually different, and the absolute value of the difference thereof is 0.3 eV or less,
(b) side chain having hole transportability, wherein the value of HOMO energy of the side chain and the value of HOMO energy of the conjugated polymer main chain are mutually different, and the absolute value of the difference thereof is 0.3 eV or less,
(c) side chain having electron transportability and hole transportability, wherein the value of LUMO energy of the side chain and the value of LUMO energy of the conjugated polymer main chain are mutually different, and the absolute value of the difference thereof is 0.3 eV or less, and the value of HOMO energy of the side chain and the value of HOMO energy of the conjugated polymer main chain are mutually different, and the absolute value of the difference thereof is 0.3 eV or less.

### TECHNICAL FIELD

The present invention relates to a polymer compound and a polymer light emitting device (polymer LED) using the same.

### BACKGROUND ART

Macromolecular light emitting materials are usually soluble in a solvent, thus, capable of forming an organic layer in a light emitting device by a coating method, corresponding to requirements for the device such as enlargement of area and the like. Therefore, there are recently suggested polymer compounds which can be used as various polymer light emitting materials, and polymer light emitting devices using them (for example, Advanced Materials Vol. 12 1737-1750 (2000)).

Light emitting devices are desired to have higher stability, namely, longer lifetime; further, higher light emission efficiency thereof, namely, higher light emission luminance per current. When conventional polymer compounds are used in light emitting devices, however, the balance between the efficiency and the life of the devices are not sufficient yet.

### DISCLOSURE OF THE INVENTION

An object of the present invention is to provide a polymer compound which, when used as a material of a light emitting device, is capable of providing the light emitting device having longer lifetime and higher light emission efficiency with good balance.

That is, in a first embodiment, the present invention provides a polymer compound having a conjugated polymer main chain and at least one side chain selected from the following (a), (b) and (c):

(a) side chain having electron transportability, wherein the value of LUMO energy of the side chain and the value of LUMO energy of the conjugated polymer main chain are mutually different, and the absolute value of the difference thereof is 0.3 eV or less,

(b) side chain having hole transportability, wherein the value of HOMO energy of the side chain and the value of HOMO energy of the conjugated polymer main chain are mutually different, and the absolute value of the difference thereof is 0.3 eV or less,

(c) side chain having electron transportability and hole transportability, wherein the value of LUMO energy of the side chain and the value of LUMO energy of the conjugated polymer main chain are mutually different, and the absolute value of the difference thereof is 0.3 eV or less, and the value of HOMO energy of the side chain and the value of HOMO energy of the conjugated polymer main chain are mutually different, and the absolute value of the difference thereof is 0.3 eV or less.

Further, in a second embodiment, the present invention provides a polymer compound containing a repeating unit represented by the following general formula (4) and having a group of the following general formula (2).

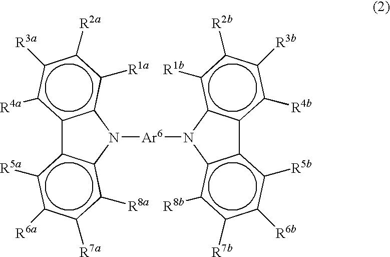

[wherein, Ar⁶ represents a biphenyl-4,4′-diyl group, fluorene-2,7-diyl group, phenanthrene-3,8-diyl group, triphenylamine-4,4′-diyl group, or divalent group obtained by mutual connection of two or more groups selected independently from them. The Ar⁶ optionally has a substituent. R^{1a} to R^{8a} and R^{1b} to R^{8b} represent each independently a hydrogen atom, halogen atom, C₁-C₁₂ alkyl group, C₆-C₂₆ aryl group, C₃-C₂₀ hetero aryl group, C₁-C₁₂ alkyloxy group, C₆-C₂₆ aryloxy group, C₃-C₂₀ hetero aryloxy group, C₁-C₁₂ alkylthio group, C₆-C₂₆ arylthio group, C₃-C₂₀ hetero arylthio group, C₂-C₁₂ alkenyl group, C₂-C₁₂ alkynyl group, —NQ²Q³ (wherein, Q² and Q³ represent each independently a hydrogen atom, C₁-C₁₂ alkyl group, C₆-C₂₆ aryl group or C₃-C₂₀ hetero aryl group), —C≡N, —NO₂, connecting bond or group represented by -Z′- (wherein, Z′ is a linear, branched or cyclic C₁-C₂₀ alkylene group, C₆-C₂₆ arylene group, divalent C₃-C₂₀ hetero aromatic group, —O—, —S—, —C(═O)—, or divalent group obtained by combination of two or more groups selected from these groups). Here, at least one of R^{1a} to R^{8a} and R^{1b} to R^{8b} is a connecting bond or a group represented by -Z′-.]

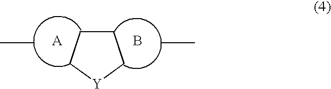

[wherein, A ring and B ring represent each independently an aromatic hydrocarbon ring optionally having a substituent, two connecting bonds are present respectively on the A ring and B ring, and Y represents an atom or atom group forming a 5-membered ring or 6-membered ring together with two atoms on the A ring and two atoms on the B ring.].

### MODES FOR CARRYING OUT THE INVENTION

The conjugated polymer main chain in the present invention means a main chain composed of a conjugated polymer. The conjugated polymer in the present invention is a polymer compound having a conjugated system spread on the main chain skeleton, and examples thereof include polyarylenes having as a constituent unit an arylene group such as polyfluorene and polyphenylene; polyheteroarylenes having as a constituent unit a divalent hetero aromatic group such as polythiophene and polydibenzofuran; polyarylenevinylenes such as polyphenylenevinylene and the like, or copolymers having such constituent units in combination. Further, hetero atoms and the like may be contained as a constituent unit in a main chain providing that conjugation is substantially attained, and constituent units derived from triphenylamine and the like may also be contained as a constituent unit.

Among conjugated polymer main chains in the polymer compound of the present invention, those containing a repeating unit represented by the following general formula (4) are preferable from the standpoint of efficiency and lifetime when the polymer compound of the present invention is used in a polymer light emitting device.

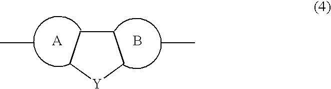

[wherein, A ring and B ring represent each independently an aromatic hydrocarbon ring optionally having a substituent, two connecting bonds are present respectively on the A ring and B ring, and Y represents an atom or atom group forming a 5-membered ring or 6-membered ring together with two atoms on the A ring and two atoms on the B ring.].

In the above-described formula (4), the aromatic hydrocarbon rings represented by the A ring and B ring represent each independently a benzene ring, naphthalene ring, anthracene ring or the like. These rings optionally have a substituent.

In the above-described formula (4), Y includes groups containing, for example, a carbon atom, oxygen atom, nitrogen atom or sulfur atom, and specific example includes divalent groups such as —C(Q⁴)(Q⁵)-, —C(═O)—, —O—, —S—, —SO₂—, —N(Q⁶)- and the like, and divalent groups obtained by connecting two groups selected from them, such as —OC(Q⁴)(Q⁵)-, —N(Q⁶)C(Q⁴)(Q⁵)- and the like. Q⁴, Q⁵ and Q⁶ represent each independently a hydrogen atom, C₁-C₁₂ alkyl group, C₆-C₂₆ aryl group or C₃-C₂₀ hetero aryl group.

The C₁-C₁₂ alkyl group (C₁-C₁₂ means that the carbon atom number is 1 to 12) may be linear, branched or cyclic, and examples include a methyl group, ethyl group, propyl group, 2-propyl group, butyl group, sec-butyl group, tert-butyl group, pentyl group, 2-methylbutyl group, isoamyl group, hexyl group, cyclohexyl group, cyclohexylmethyl group, octyl group, nonyl group, decyl group and the like.

As the C₁-C₁₂ alkyl group represented by Q⁴, Q⁵ and Q⁶, C₅-C₈ alkyl groups such as a 2-methylbutyl group, hexyl group, octyl group and the like are particularly preferable from the standpoint of solubility thereof.

Examples of the C₆-C₂₆ aryl group include a phenyl group, 4-tolyl group, 4-hexylphenyl group, 4-octylphenyl group, 1-naphthyl group, 2-naphthyl group, 2-methoxyphenyl group, 4-methoxyphenyl group, 4-hexyloxyphenyl group, 4-(2-ethoxyethyloxy)phenyl group, 9-anthranyl group and the like. The aryl group optionally has a condensed ring.

As the C₆-C₂₆ aryl group represented by Q⁴, Q⁵ and Q⁶, phenyl groups substituted by an alkyl group or alkoxy group such as a 4-hexylphenyl group, 4-octylphenyl group, 2-methoxyphenyl group, 4-methoxyphenyl group, 4-hexyloxyphenyl group, 4-(2-ethoxyethyloxy)phenyl group and the like are particularly preferable from the standpoint of solubility.

Examples of the C₃-C₂₀ hetero aryl group include a 2-pyridyl group, 3-pyridyl group, 4-pyridyl group, 2-thienyl group and the like. The hetero aryl group optionally has a condensed ring.

Examples of the repeating unit represented by the above-described formula (4) include a fluorenediyl group, benzofluorenediyl group, dibenzofuranediyl group, dibenzothiophenediyl group, carbazolediyl group, dibenzopyranediyl group, phenanthrenediyl group and the like optionally having a substituent, and preferable is a fluorenediyl group optionally having a substituent or a benzofluorenediyl group optionally having a substituent.

The polymer compound of the present invention has, in a first embodiment, at least one side chain selected from the following (a), (b) and (c), in addition to the above-described conjugated polymer main chain.

(a) side chain having electron transportability, wherein the value of LUMO energy of the side chain and the value of LUMO energy of the conjugated polymer main chain are mutually different, and the absolute value of the difference thereof is 0.3 eV or less. The absolute value of the difference thereof is preferably 0.2 eV or less, more preferably 0.15 eV or less. The absolute value is preferably 0.01 eV or more, more preferably 0.05 eV or more.

(b) side chain having hole transportability, wherein the value of HOMO energy of the side chain and the value of HOMO energy of the conjugated polymer main chain are mutually different, and the absolute value of the difference thereof is 0.3 eV or less. The absolute value of the difference thereof is preferably 0.2 eV or less, more preferably 0.15 eV or less. The absolute value is preferably 0.01 eV or more, more preferably 0.05 eV or more.

(c) side chain having electron transportability and hole transportability, wherein the value of LUMO energy of the side chain and the value of LUMO energy of the conjugated polymer main chain are mutually different, and the absolute value of the difference thereof is 0.3 eV or less, and the value of HOMO energy of the side chain and the value of HOMO energy of the conjugated polymer main chain are mutually different, and the absolute value of the difference thereof is 0.3 eV or less. The absolute value of the difference thereof is preferably 0.2 eV or less, more preferably 0.15 eV or less. The absolute value is preferably 0.01 eV or more, more preferably 0.05 eV or more.

The polymer compound of the present invention may have two or more side chains selected from the above-described (a), (b) and (c).

The polymer compound of the present invention may have other side chains than the side chain selected from the above-described (a), (b) and (c).

As the at least one side chain selected from the above-described (a), (b) and (c) contained in the polymer compound of the present invention, side chains according to (a) or (c) are preferable, and of them, side chains according to (c) are more preferable.

LUMO (Lowest Unoccupied Molecular Orbital) means a molecular orbital having lowest energy among molecular orbitals containing no electron, while HOMO (Highest Occupied Molecular Orbital) means a molecular orbital having highest energy among molecular orbitals containing electrons, and the value of LUMO and HOMO energy of the side chain in the above-described (a), (b) and (c) is a value of energy obtained by carrying out molecular orbital calculation on a model compound obtained by adding a hydrogen atom to the side chain.

The molecular orbital calculation can be carried out as described below.

That is, for the above-described model compound, a calculation for obtaining the most stable structure is carried out (calculation is repeated until reaching final convergence by key word: AM1 PRECISE EF) by AM1 method (dewar, M. J. S. et al, J. Am. Chem. Soc., 107, 3902 (1985)) using a semi-empirical molecular orbital method MOPAC 2002 Version 1.00, thereby, the energy value and distribution of LUMO and HOMO of the model compound can be obtained.

The value of LUMO and HOMO energy of the conjugated polymer main chain is a value of energy obtained by carrying out molecular orbital calculation according to the same method as described above on a model compound determined as described below.

The model compound used for calculation of the value of LUMO and HOMO energy of the conjugated polymer main chain is determined as described below by the structure of a polymer obtained by substitution with a hydrogen atom of all side chains contained in a polymer compound as calculation subject.

(i) When the polymer is a homopolymer, an alternating copolymer, or a periodic copolymer which is a copolymer containing three or more subunits arranged regularly:

A compound obtained by connecting two hydrogen atoms to a divalent group containing three continuous constituent repeating units constituting a main chain.

[example] in the case of a homopolymer composed of constituent units A ( . . . -A-A-A-A-A- . . . ): mode compound H-A-A-A-H (A is constituent repeating unit)

[example] in the case of an alternating copolymer composed of subunits A and B ( . . . -A-B-A-B-A-B- . . . ): mode compound H-A-B-A-B-A-B-H (-A-B- is constituent repeating unit)

(ii) When the polymer is a random copolymer:

A compound obtained by connecting two hydrogen atoms to a divalent group containing three continuous repeating units, the repeating unit having a configuration in which the same components are placed at the remotest positions with the minimum unit (combination of subunits) corresponding to the ratio of subunits constituting the random copolymer.

[example] in the case of random copolymer in which A:B is 1:2

:model compound H-A-B-A-A-B-A-A-B-A-H

(-A-B-A- is a repeating unit having a configuration in which the same components are placed at the remotest positions with the minimum unit (combination of subunits) corresponding to the ratio of subunits)

(iii) When the polymer is a block copolymer:

When the block containing subunits in a main chain to which a side chain selected from (a), (b) and (c) is connected is composed of any of a homopolymer, an alternating copolymer and a periodic copolymer which is a copolymer containing three or more subunits arranged regularly, a model compound is determined by the above-described (a), and when composed of a random copolymer, a model compound is determined by the above-described (b).

When there are several kinds of blocks to which the above-described side chain is connected, a value nearest to the value of LUMO energy of a side chain, among the values of LUMO energy calculated by a similar method, is recognized as LUMO energy of a main chain, for all the blocks

Further, a value nearest to the value of HOMO energy of a side chain, among the values of HOMO energy calculated by a similar method, is recognized as HOMO energy of a main chain, for all the blocks.

The side chain having electron transportability in the above-described (a) is a side chain (including group) having a partial structure having a function of transporting electrons, and includes those having a conjugated structure of two or more aromatic rings having delocalized LUMO distribution, and in the broad sense, an electron injecting group and a hole blocking group are also included in the electron transportable group. Partial structures of those conventionally used as an electron charge injection and transporting material and known compounds used in an electron injection layer and electron transporting layer of an EL device, can be used.

Specific structures thereof include, for example, groups having a conjugated structure containing a nitrogen-containing aromatic ring such as a pyridine ring, oxadiazole ring and triazole ring, and more specifically, groups having a partial structure of compounds as shown below.

Here, a connecting bond is provided at any atom site of compounds shown below, giving a side chain having electron transportability.

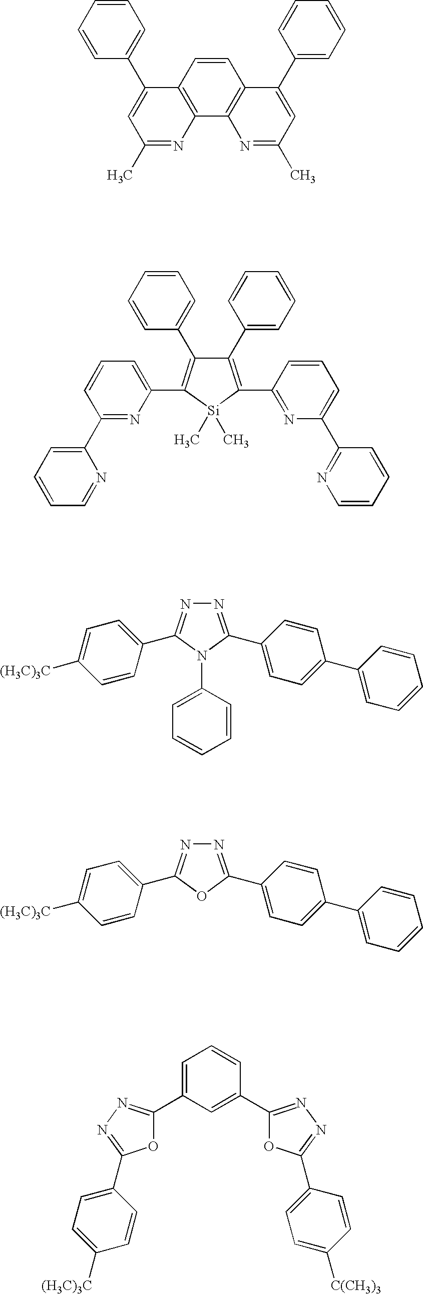

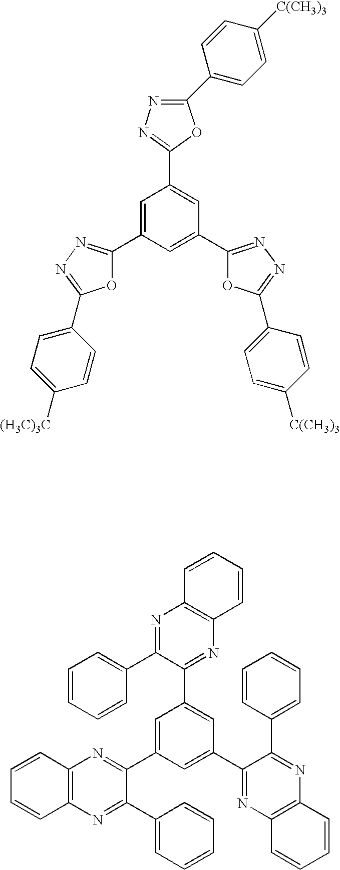

The side chain having hole transportability in the above-described (b) is a side chain (including group) having a partial structure having a function of transporting holes, and includes those having a conjugated structure of two or more aromatic rings having delocalized HOMO distribution, and in the broad sense, a hole injecting group and an electron blocking group are also included in the hole transportable group. Side chains having a partial structure of those conventionally used as a hole charge injection and transporting material and known compounds used in a hole injection layer and hole transporting layer of an EL device, can be used.

Specific structures thereof include groups having an aromatic amine skeleton and groups having a carbazole skeleton, and more specifically, groups having a partial structure of compounds as shown below are mentioned.

(Here, a connecting bond is provided at any atom site of compounds shown below, giving a side chain having hole transportability.)

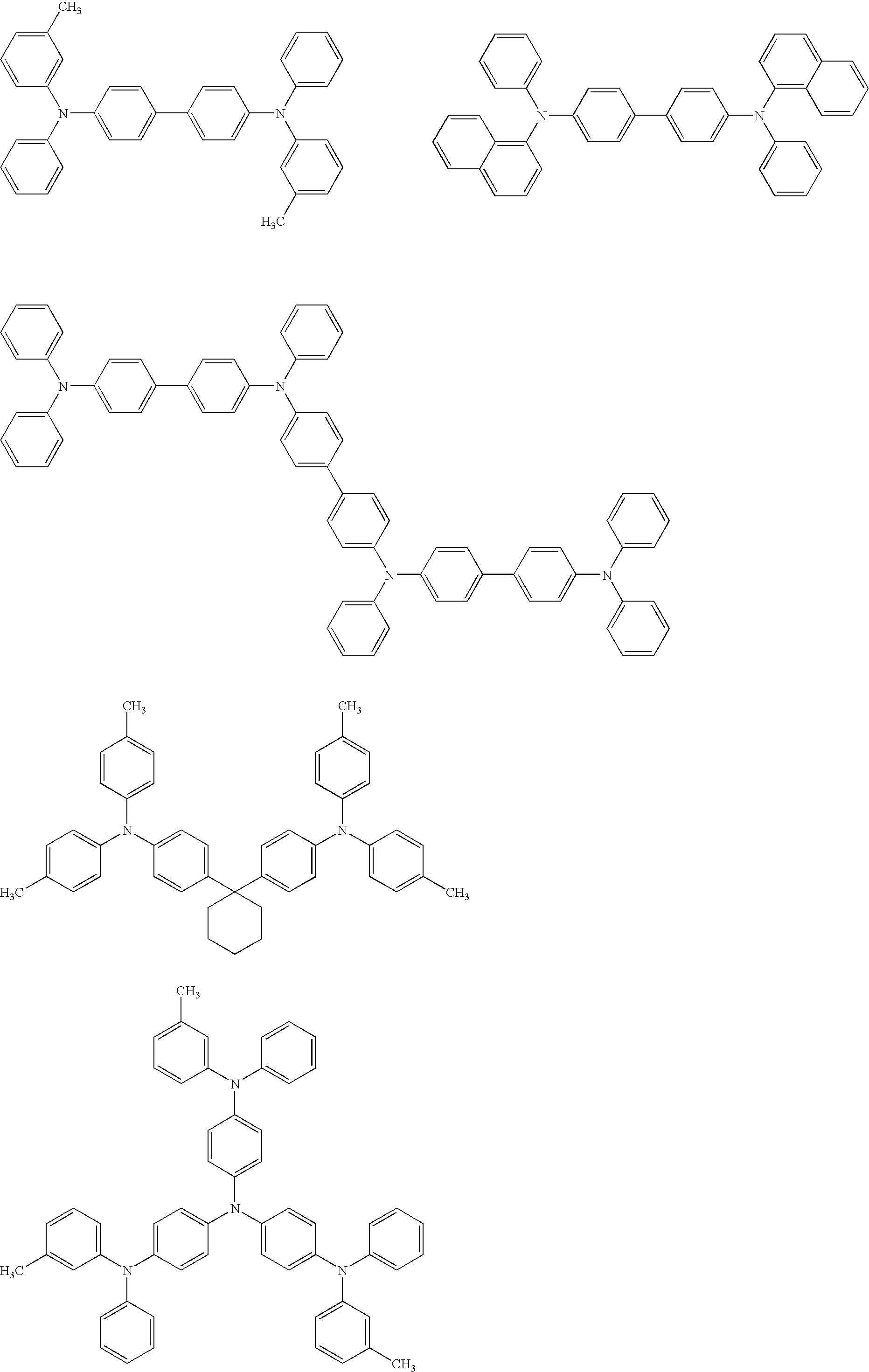

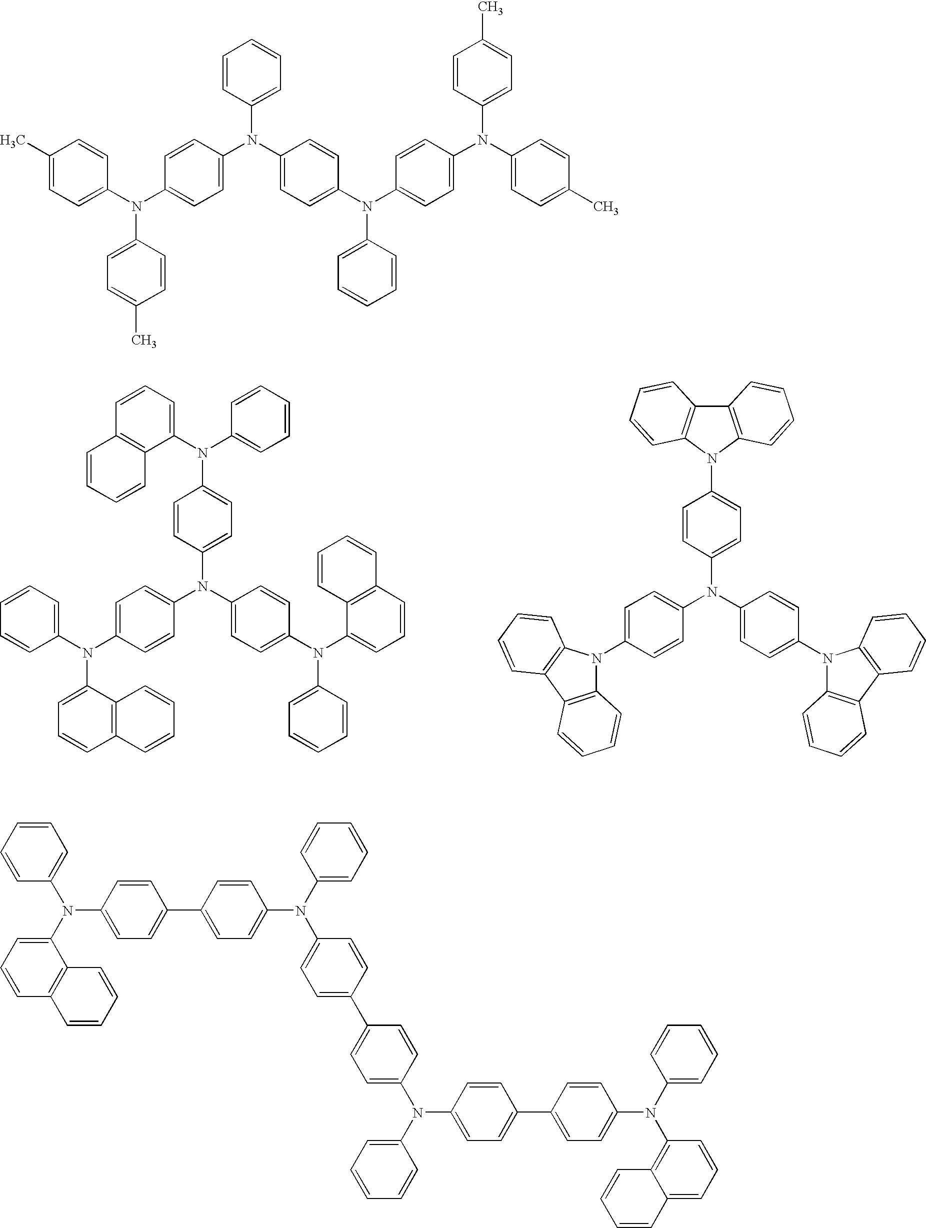

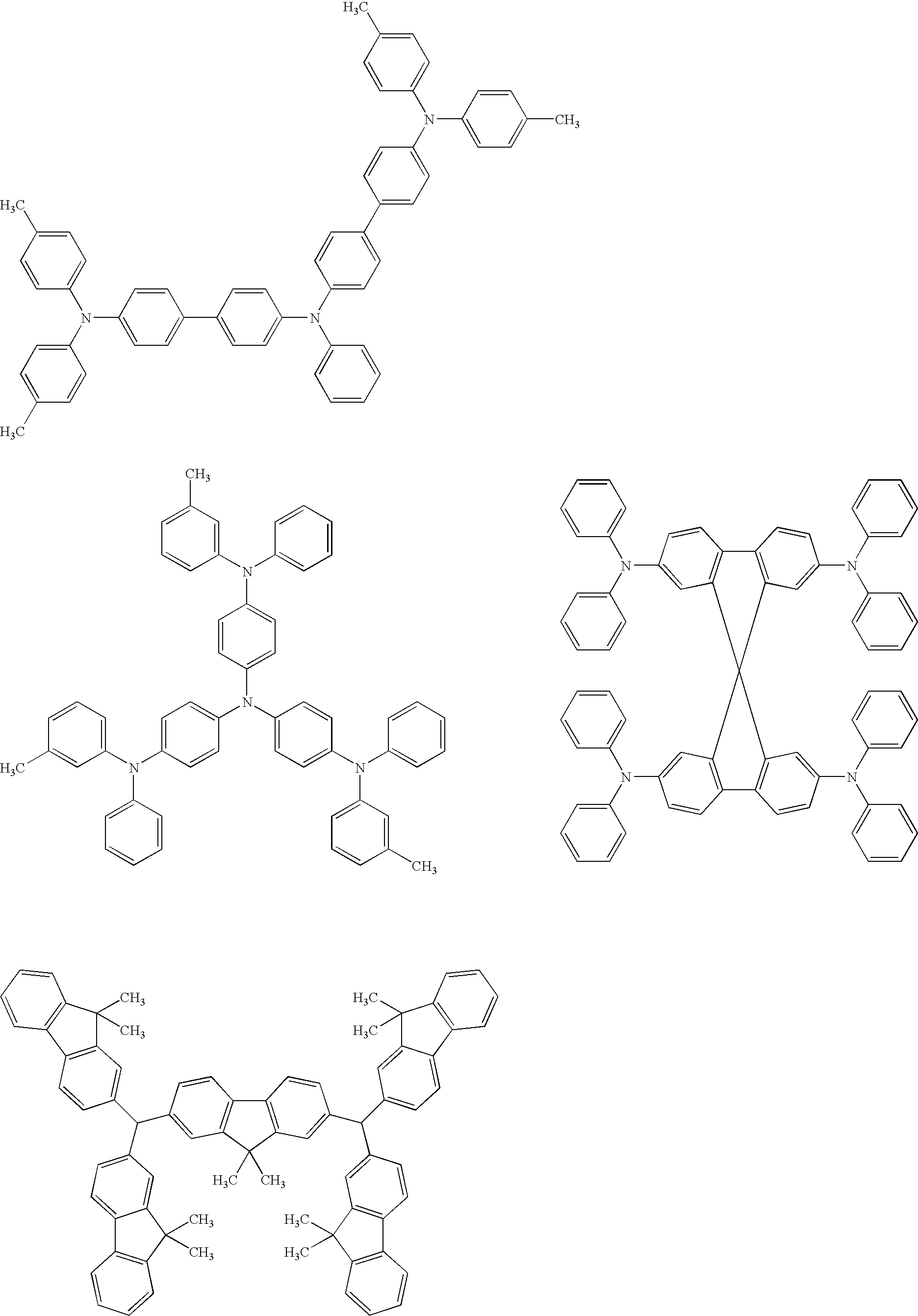

The side chain having electron transportability and hole transportability in the above-described (c) is a side chain (including group) having a partial structure having a function of transporting electrons and holes, and has a structure of conjugation of two or more aromatic rings having delocalized HOMO distribution and a structure of conjugation of two or more aromatic rings having delocalized LUMO distribution.

Specific examples of the side chain having electron transportability and hole transportability include groups containing a structure of (4,4′-bis(9-carbazoyl)-biphenyl) (CBP) known as a compound having both electron transportability and hole transportability represented by the following formula.

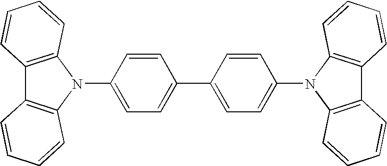

Among side chains selected from (a), (b) and (c) contained in the polymer compound of the present invention, preferable are compound residues having a connecting bond on at least one bonding site which has been bonded by a hydrogen atom of a compound of the following general formula (1), or a compound residue obtained by further connecting a group represented by -Z- to said residue s:

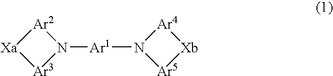

[wherein, Ar¹ represents a C₆-C₂₆ arylene group, divalent C₃-C₂₀ hetero aromatic group, triphenylamine-4,4′-diyl group, or divalent aromatic group obtained by connecting two or more groups selected from these groups directly or via a divalent group represented by —N(Q¹)- (wherein, Q¹ represents a hydrogen atom, C₁-C₁₂ alkyl group, C₆-C₂₆ aryl group or C₃-C₂₀ hetero aryl group), Ar², Ar³, Ar⁴ and Ar⁵ represent each independently a C₆-C₂₆ arylene group or divalent C₃-C₂₀ hetero aromatic group, Xa represents an atom or atom group or a direct bond for forming a 6-membered ring together with Ar², Ar³ and nitrogen atom, Xb represents an atom or atom group or a direct bond for forming a 6-membered ring together with Ar⁴, Ar⁵ and nitrogen atom. Z represents a divalent group.].

The number of carbon atoms constituting a ring of a C₆-C₂₆ arylene group represented by Ar¹, Ar², Ar³, Ar⁴ and Ar⁵ in the above-described formula (1) is from 6 to 26. Specific examples of this arylene group include a phenylene group, biphenyldiyl group, terphenyldiyl group, naphthalenediyl group, anthracenediyl group, phenanthrenediyl group, pentalenediyl group, indenediyl group, heptalenediyl group, indacenediyl group, triphenylenediyl group, binaphthyldiyl group, phenylnaphthylenediyl group, stilbenediyl group, fluorenediyl group and the like. The arylene group represented by Ar¹, Ar², Ar³, Ar⁴ and Ar⁵ optionally has a substituent, and the carbon number including the substituent is about from 6 to 60.

The number of carbon atoms constituting a ring of a divalent C₃-C₂₀ hetero aromatic group represented by Ar¹, Ar², Ar³, Ar⁴ and Ar⁵ is from 3 to 20. Here, the divalent hetero aromatic group means a residual atom group after removing two hydrogen atoms from an aromatic heterocyclic compound. Specific examples of this divalent heterocyclic group include a pyridine-diyl group, diazaphenylene group, quinolinediyl group, quinoxalinediyl group, acridinediyl group, bipyridyldiyl group, phenanthrolinediyl group and the like. The divalent C₃-C₂₀ hetero aromatic group represented by Ar¹, Ar², Ar³, Ar⁴ and Ar⁵ optionally has a substituent, and the carbon number including the substituent is about from 3 to 60.

The substituent optionally carried on the C₆-C₂₆ arylene group and divalent C₃-C₂₀ hetero aromatic group represented by Ar¹, Ar², Ar³, Ar⁴ and Ar⁵ includes halogen atoms, C₁-C₁₂ alkyl groups, C₆-C₂₆ aryl groups, C₃-C₂₀ hetero aryl groups, C₁-C₁₂ alkyloxy groups, C₆-C₂₆ aryloxy groups, C₃-C₂₀ hetero aryloxy groups, C₁-C₁₂ alkylthio groups, C₆-C₂₆ arylthio groups, C₃-C₂₀ hetero arylthio groups, C₂-C₁₂ alkenyl groups, C₂-C₁₂ alkynyl groups, —N(Q²)(Q³) (wherein, Q² and Q³ represent each independently a hydrogen atom, C₁-C₁₂ alkyl group, C₆-C₂₆ aryl group or C₃-C₂₀ hetero aryl group), —C≡N and —NO₂.

The halogen atom includes a fluorine atom, chlorine atom, bromine atom and iodine atom.

Examples of the C₁-C₁₂ alkyl group include the same groups as mentioned for the C₁-C₁₂ alkyl group in the above-described explanation of Q⁴, Q⁵, Q⁶

Examples of the C₆-C₂₆ aryl group, include the same groups as mentioned for the C₆-C₂₆ aryl group in the above-described explanation of Q⁴, Q⁵, Q⁶.

Examples of the C₃-C₂₀ hetero aryl group include the same groups as mentioned for the C₃-C₂₀ hetero aryl group in the above-described explanation of Q⁴, Q⁵, Q⁶.

The C₁-C₁₂ alkyloxy group may be linear, branched or cyclic, and examples include a methoxy group, ethoxy group, propyloxy group, 2-propyloxy group, butyloxy group, sec-butyloxy group, tert-butyloxy group, pentyloxy group, 2-methylbutyloxy group, isoamyloxy group, hexyloxy group, cyclohexyloxy group, cyclohexylmethyloxy group, octyloxy group, nonyloxy group, decyloxy group and the like.

Examples of the C₆-C₂₆ aryloxy group include a phenoxy group, 1-naphthyloxy group, 2-naphthyloxy group and the like.

Examples of the C₃-C₂₀ hetero aryloxy group include a 2-thienyloxy group and the like.

Examples of the C₁-C₁₂ alkylthio group include those obtained by substitution by a sulfur atom of an oxygen atom in the examples of the above-described C₁-C₁₂ alkyloxy group.

Examples of the C₆-C₂₆ arylthio group include those obtained by substitution by a sulfur atom of an oxygen atom in the examples of the above-described C₆-C₂₆ aryloxy group.

Examples of the C₃-C₂₀ hetero arylthio group include those obtained by substitution by a sulfur atom of an oxygen atom in the examples of the above-described C₃-C₂₀ hetero aryloxy group.

Examples of the C₂-C₁₂ alkenyl group, include an ethenyl group, propenyl group, 1-styryl group, 2-styryl group and the like.

Examples of the C₂-C₁₂ alkynyl group include an acetylenyl group, propynyl group, phenylacetylenyl group and the like.

Examples of the group represented by —N(Q²)(Q³), include an amino group, dimethylamino group, diethylamino group, diphenylamino group, di-(4-tolyl)amino group, di-(4-methoxyphenyl)amino group, benzylamino group and the like.

The substituent optionally carried on the C₆-C₂₆ arylene group and divalent C₃-C₂₀ hetero aromatic group represented by Ar¹, Ar², Ar³, Ar⁴ and Ar⁵ includes C₁-C₁₂ alkyl groups, C₆-C₂₆ aryl groups and groups represented by —N(Q²)(Q³) are preferable.

Among groups represented by Ar¹, an optionally substituted phenylene group, an optionally substituted biphenyldiyl group, or a group represented by the following structural formula (3):

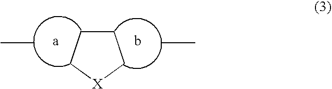

[wherein, a ring and b ring represent each independently an aromatic hydrocarbon ring optionally having a substituent, two connecting bonds are present respectively on the a ring and/or b ring, and X represents an atom or atom group forming a 5-membered ring or 6-membered ring together with two atoms on the a ring and two atoms on the b ring.].
is preferable from the standpoint of efficiency and lifetime when the polymer compound of the present invention is used in a polymer light emitting device.

In the above-described formula (3), the aromatic hydrocarbon rings represented by the a ring and b ring represent each independently a benzene ring, naphthalene ring, anthracene ring or the like. These rings optionally have a substituent.

Examples of X in the above-described formula (3) include groups containing a carbon atom, oxygen atom, nitrogen atom or sulfur atom, and specifically, divalent groups such as —C(Q⁷)(Q⁸)-, —C(═O)—, —O—, —S—, —SO₂—, —N(Q⁹)- and the like, and divalent groups obtained by connecting two groups selected from them, are mentioned. Q⁷, Q⁸, Q⁹ represent each independently a hydrogen atom, C₁-C₁₂ alkyl group, C₆-C₂₆ aryl group or C₃-C₂₀ hetero aryl group.

Examples of the C₁-C₁₂ alkyl group include the same groups as mentioned for the C₁-C₁₂ alkyl group in the above-described explanation of Q⁴, Q⁵, Q⁶.

Examples of the C₆-C₂₆ aryl group include the same groups as mentioned for the C₆-C₂₆ aryl group in the above-described explanation of Q⁴, Q⁵, Q⁶.

Examples of the C₃-C₂₀ hetero aryl group include the same groups as mentioned for the C₃-C₂₀ hetero aryl group in the above-described explanation of Q⁴, Q⁵, Q⁶.

Examples of the group of the above-described formula (3) include a fluorenediyl group, dibenzofuranediyl group, dibenzothiophenediyl group, carbazolediyl group, dibenzopyranediyl group, phenanthrenediyl group and the like optionally having a substituent.

Of them, groups obtained by substitution by a connecting bond or -Z- (Z represents a divalent group) of one hydrogen atom in compounds of the following general formula (1) are preferable from the standpoint of easiness of synthesis.

As the divalent group represented by -Z-, linear, branched or cyclic C₁-C₂₀ alkylene groups, C₆-C₂₆ arylene groups, divalent C₃-C₂₀ hetero aromatic groups, —O—, —S—, —N(Q¹⁰)-, —C(═O)—, or divalent groups obtained by combination of two or more groups selected from them are preferable from the standpoint of easiness of synthesis. Q¹⁰ represents a hydrogen atom, C₁-C₁₂ alkyl group optionally having a substituent, C₆-C₂₆ aryl group optionally having a substituent or C₃-C₂₀ hetero aryl group optionally having a substituent.

Examples of the C₁-C₁₂ alkyl group include the same groups as mentioned for the C₁-C₁₂ alkyl group in the above-described explanation of Q⁴, Q⁵, Q⁶.

Examples of the C₆-C₂₆ aryl group include the same groups as mentioned for the C₆-C₂₆ aryl group in the above-described explanation of Q⁴, Q⁵, Q⁶.

Examples of the C₃-C₂₀ hetero aryl group include the same groups as mentioned for the C₃-C₂₀ hetero aryl group in the above-described explanation of Q⁴, Q⁵, Q⁶.

The C₁-C₂₀ alkylene group may be linear, branched or cyclic, and examples thereof include a methylene group, 1,2-ethanediyl group, 1,1-ethanediyl group, 1,3-propanediyl group, 1,2-propanediyl group, 1,4-butanediyl group, 1,2-cyclopentanediyl group, 1,6-hexanediyl group, 1,4-cyclohexanediyl group, 1,2-cyclohexanediyl group, 1,8-octanediyl group, 1,10-decanediyl group and the like.

In the above-described formula (1), Xa represents a direct bond, or an atom or atom group for forming a 6-membered ring together with Ar², Ar³, nitrogen atom, and Xb represents a direct bond, or an atom or atom group for forming a 6-membered ring together with Ar⁴, Ar⁵, nitrogen atom.

The atom or atom group for forming a 6-membered ring together with Ar², Ar³, nitrogen atom, and the atom or atom group for forming a 6-membered ring together with Ar⁴, Ar⁵, nitrogen atom include —O—, —S—, —N(Q¹¹)- and the like. Q¹¹ represents a hydrogen atom, a C₁-C₁₂ alkyl group optionally having a substituent, a C₆-C₂₆ aryl group optionally having a substituent or a C₃-C₂₀ hetero aryl group optionally having a substituent.

Examples of the C₁-C₁₂ alkyl group include the same groups as mentioned for the C₁-C₁₂ alkyl group in the above-described explanation of Q⁴, Q⁵, Q⁶

Examples of the C₆-C₂₆ aryl group include the same groups as mentioned for the C₆-C₂₆ aryl group in the above-described explanation of Q⁴, Q⁵, Q⁶

Examples of the C₃-C₂₀ hetero aryl group include the same groups as mentioned for the C₃-C₂₀ hetero aryl group in the above-described explanation of Q⁴, Q⁵, Q⁶.

As Xa, Xb, preferable is a direct bond.

Among groups of the above-described formula (1), groups of the following general formula (2) are preferable.

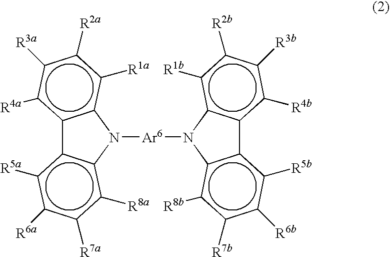

[wherein, Ar⁶ represents a biphenyl-4,4′-diyl group, fluorene-2,7-diyl group, phenanthrene-3,8-diyl group, triphenylamine-4,4′-diyl group or divalent group obtained by mutual connection of two or more groups selected independently from them. The Ar⁶ optionally has a substituent. R^{1a} to R^{8a} and R^{1b} to R^{8b} represent each independently a hydrogen atom, halogen atom, C₁-C₁₂ alkyl group, C₆-C₂₆ aryl group, C₃-C₂₀ hetero aryl group, C₁-C₁₂ alkyloxy group, C₆-C₂₆ aryloxy group, C₃-C₂₀ hetero aryloxy group, C₁-C₁₂ alkylthio group, C₆-C₂₆ arylthio group, C₃-C₂₀ hetero arylthio group, C₂-C₁₂ alkenyl group, C₂-C₁₂ alkynyl group, —NQ²Q³ (wherein, Q² and Q³ represent each independently a hydrogen atom, C₁-C₁₂ alkyl group, C₆-C₂₆ aryl group or C₃-C₂₀ hetero aryl group), —C≡N, —NO₂, connecting bond or group represented by -Z′- (wherein, Z′ is a linear, branched or cyclic C₁-C₂₀ alkylene group, C₆-C₂₆ arylene group, divalent C₃-C₂₀ hetero aromatic group, —O—, —S—, —N(Q¹⁴)-, —C(═O)—, or divalent group obtained by combination of two or more groups selected from these groups (here, Q¹⁴s represent each independently a hydrogen atom, C₁-C₁₂ alkyl group, C₆-C₂₆ aryl group or C₃-C₂₀ hetero aryl group)). Here, at least one of R^{1a} to R^{8a} and R^{1b} to R^{8b} is a connecting bond or a group represented by -Z′-.].

As the halogen atom, C₁-C₁₂ alkyl group, C₆-C₂₆ aryl group, C₃-C₂₀ hetero aryl group, C₁-C₁₂ alkyloxy group, C₆-C₂₆ aryloxy group, C₃-C₂₀ hetero aryloxy group, C₁-C₁₂ alkylthio group, C₆-C₂₆ arylthio group, C₃-C₂₀ hetero arylthio group, C₂-C₁₂ alkenyl group, C₂-C₁₂ alkynyl group and —N(Q¹²)(Q¹³) represented by R^{1a} to R^{8a} and R^{1b} to R^{8b}, examples thereof include the same groups as the group and halogen atom, C₁-C₁₂ alkyl group, C₆-C₂₆ aryl group, C₃-C₂₀ hetero aryl group, C₁-C₁₂ alkyloxy group, C₆-C₂₆ aryloxy group, C₃-C₂₀ hetero aryloxy group, C₁-C₁₂ alkylthio group, C₆-C₂₆ arylthio group, C₃-C₂₀ hetero arylthio group, C₂-C₁₂ alkenyl group, C₂-C₁₂ alkynyl group and —N(Q²)(Q³) explained as the substituent optionally carried on the C₆-C₂₆ arylene group and divalent C₃-C₂₀ hetero aromatic group represented by the above-described Ar¹, Ar², Ar³, Ar⁴ and Ar⁵, respectively.

As the group represented by R^{1a} to R^{8a} and R^{1b} to R^{8b}, a hydrogen atom, C₁-C₁₂ alkyl group, C₆-C₂₆ aryl group and group represented by —N(Q¹²)(Q¹³) are preferable.

As the divalent group represented by -Z′- among the groups represented by R^{1a} to R^{8a} and R^{1b} to R^{8b}, preferable are linear, branched or cyclic C₁-C₂₀ alkylene groups, C₆-C₂₆ arylene groups, divalent C₃-C₂₀ hetero aromatic groups, —O—, and divalent groups obtained by combination of two or more groups selected from them, from the standpoint of easiness of synthesis.

Examples of the C₁-C₂₀ alkylene group include the same groups as mentioned for the C₁-C₂₀ alkylene group in the above-described explanation of -Z-.

Examples of the C₆-C₂₆ arylene group include the same groups as mentioned for the C₆-C₂₆ arylene group represented by the above-described Ar¹, Ar², Ar³, Ar⁴ and Ar⁵.

Examples of the divalent C₃-C₂₀ hetero aromatic group include the same groups as mentioned for the divalent C₃-C₂₀ hetero aromatic group represented by the above-described Ar¹, Ar², Ar³, Ar⁴ and Ar⁵.

Examples of the divalent group obtained by combination of two or more groups selected from the above-described groups include divalent groups represented by —R^{1c}—O—, —R^{2c}—O—R^{3c}—, —O—R^{4c}—O—, —R^{5c}—R^{6c}— (R^{1c}, R^{2c}, R^{3c} and R^{4c} represent each independently a C₁-C₂₀ alkylene group or C₆-C₂₆ arylene group, R^{5c} represents a C₁-C₂₀ alkylene group, and R^{6c} represents a C₆-C₂₆ arylene group).

Among side chains of the formula (2), those in which one of R^{1a} to R^{8a} and R^{1b} to R^{8b} is a connecting bond or -Z′- are preferable, and those in which any one of R^{3a}, R^{3b}, R^{6a} and R^{6b} is a connecting bond or -Z′- are more preferable.

Among a connecting bond and groups of -Z′-, preferable are a connecting bond, —O—, C₁-C₂₀ alkylene groups, or groups represented by —R^{2c}—O—R^{3c}—, more preferable are C₁-C₂₀ alkylene groups, or groups represented by —R^{2c}—O—R^{3c}—.

More specific examples of the group represented by —R^{2c}—O—R^{3c}— include a 1,3-phenyleneoxy-1,3-propanediyl group, 1,4-phenyleneoxy-1,3-propanediyl group, 1,4-phenyleneoxy-1,6-hexanediyl group, 1,1-ethanediyloxy-1,3-propanediyl group, 1,1-ethanediyloxy-1,6-hexanediyl group and the like.

When a repeating unit of the above-described general formula (4) is contained in a conjugated polymer main chain, in the polymer compound of the present invention, it is preferable that at least one side chain selected from (a), (b) and (c) is connected to the repeating unit of the above-described general formula (4).

In this case, at least one side chain selected from (a), (b) and (c) may be connected to the A ring or B ring, or may be connected to Y.

The content (total) of the side chain selected from (a), (b) and (c) in the polymer compound of the present invention is usually in the range of from 0.01 part by weight to 99.9 parts by weight with respect to 100 parts by weight of the whole polymer compound.

The content of the side chain of the above-described general formula (1) in the polymer compound of the present invention is usually in the range of from 0.01 part by weight to 99.9 parts by weight with respect to 100 parts by weight of the whole polymer compound. The lower limit thereof is preferably 0.1 part by weight or more, further preferably 10 parts by weight or more, still further preferably 40 parts by weight or more. The upper limit thereof is not particularly restricted, and preferably 99 parts by weight or less, and from the standpoint of easiness of synthesis, preferably 95 parts by weight or less, more preferably 91 parts by weight or less.

The polymer compound of the present invention is, in a second embodiment, a polymer compound containing a repeating unit represented by the above-described general formula (4) and having a group of the above-described general formula (2).

The polystyrene-reduced number-average molecular weight of the polymer compound of the present invention is preferably from 103 to 108, more preferably 3×10³ to 10⁶, further preferably 5×10³ to 5×10⁵ from the standpoint of solubility, film formability and the like. The polystyrene-reduced weight-average molecular weight is preferably from 10³ to 109⁸, and from the standpoint of film formability, more preferably 3×10³ to 10⁷, further preferably 5×10³ to 5×10⁶.

The polymer compound of the present invention includes homopolymers composed of a repeating unit having a side chain selected from (a), (b) and (c), random copolymer containing other repeating units in addition to the repeating unit having a side chain selected from (a), (b) and (c), alternating copolymers, block copolymers and the like.

Further, the polymer compound of the present invention includes homopolymers composed of a repeating unit represented by the above-described general formula (4) and having a group of the above-described general formula (2), random copolymer containing other repeating units in addition to the repeating unit represented by the above-described general formula (4) and having a group of the above-described general formula (2), alternating copolymers, block copolymers and the like.

As the repeating unit having a side chain selected from (a), (b) and (c) or the repeating unit represented by the above-described general formula (4) and having a group of the above-described general formula (2), preferable is a fluorenediyl group having a group of the above-described general formula (2) or a benzofluorenediyl group having a group of the above-described general formula (2),

more preferable are repeating units of the following formulae (U-01, U-02, U-03, U-05, U-11, U-12, U-13, U-15),

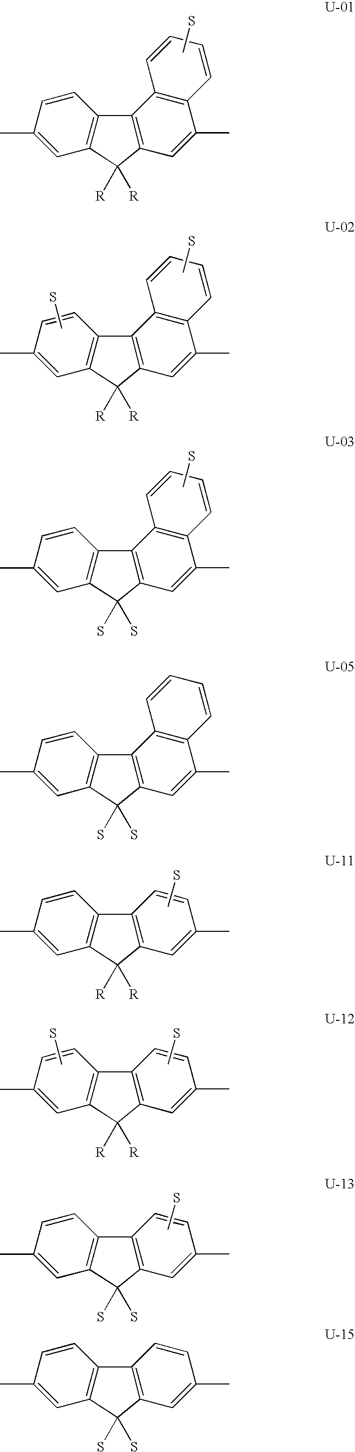

[wherein, S represents a side chain selected from (a), (b) and (c) or a group of the above-described general formula (2), and R⁵ represent each independently a hydrogen atom, C₁-C₁₂ alkyl group, C₆-C₂₆ aryl group or C₃-C₂₀ hetero aryl group. A plurality of Rs and Ss may each be the same or different.]

further preferable are repeating units represented by the above-described formulae U-01, U-05, U-11, U-15, from the standpoint of easiness of synthesis.

As the group represented by R in the above-described formulae U-01, U-02, U-03, U-05, U-11, U-12, U-13, U-15, preferable are C₁-C₁₂ alkyl groups and C₆-C₂₆ aryl groups.

Examples of the C₁-C₁₂ alkyl group represented by R in the above-described formulae U-01, U-02, U-03, U-05, U-11, U-12, U-13, U-15 include the same groups as mentioned for the C₁-C₁₂ alkyl group in the above-described explanation of Q⁴, Q⁵, Q⁶, and from the standpoint of solubility, C₅-C₈ alkyl groups such as a 2-methylbutyl group, hexyl group, octyl group and the like are particularly preferable.

Examples of the C₆-C₂₆ aryl group represented by R in the above-described formulae U-01, U-02, U-03, U-05, U-11, U-12, U-13, U-15 include the same groups as mentioned for the C₆-C₂₆ aryl group in the above-described explanation of Q⁴, Q⁵, Q⁶, and from the standpoint of solubility, phenyl groups substituted by an alkyl group or alkoxy group such as a 4-hexylphenyl group, 4-octylphenyl group, 2-methoxyphenyl group, 4-methoxyphenyl group, 4-hexyloxyphenyl group, 4-(2-ethoxyethyloxy)phenyl group and the like, are particularly preferable.

Examples of the C₃-C₂₀ hetero aryl group represented by R in the above-described formulae U-01, U-02, U-03, U-05, U-11, U-12, U-13, U-15 include the same groups as mentioned for the C₃-C₂₀ hetero aryl group in the above-described explanation of Q⁴, Q⁵, Q⁶.

As the repeating unit having a side chain selected from (a), (b) and (c) or the repeating unit represented by the above-described general formula (4) and having a group of the above-described general formula (2), more preferable are repeating units of the following general formulae.

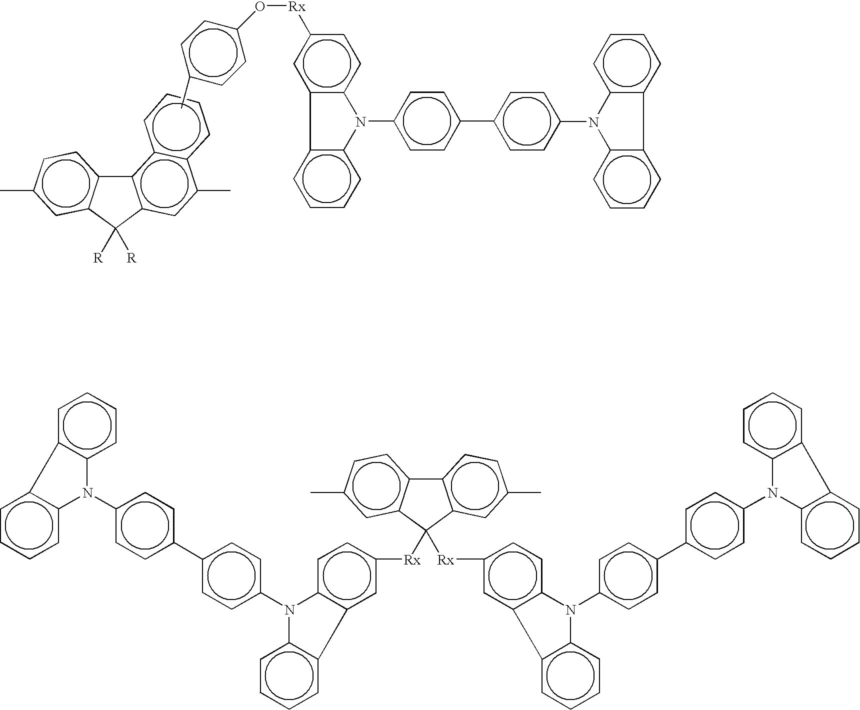

[wherein, R represents the same meaning as described above, and Rx represents a linear, branched or cyclic C₁-C₂₀ alkylene group, C₆-C₂₆ arylene group, divalent C₃-C₂₀ hetero aromatic group or divalent group obtained by combination of two or more groups selected from them. A plurality of Rxs may be the same or different.].

As the repeating unit having a side chain selected from (a), (b) and (c) or the repeating unit represented by the above-described general formula (4) and having a group of the above-described general formula (2), more specifically, the following repeating units are preferable.

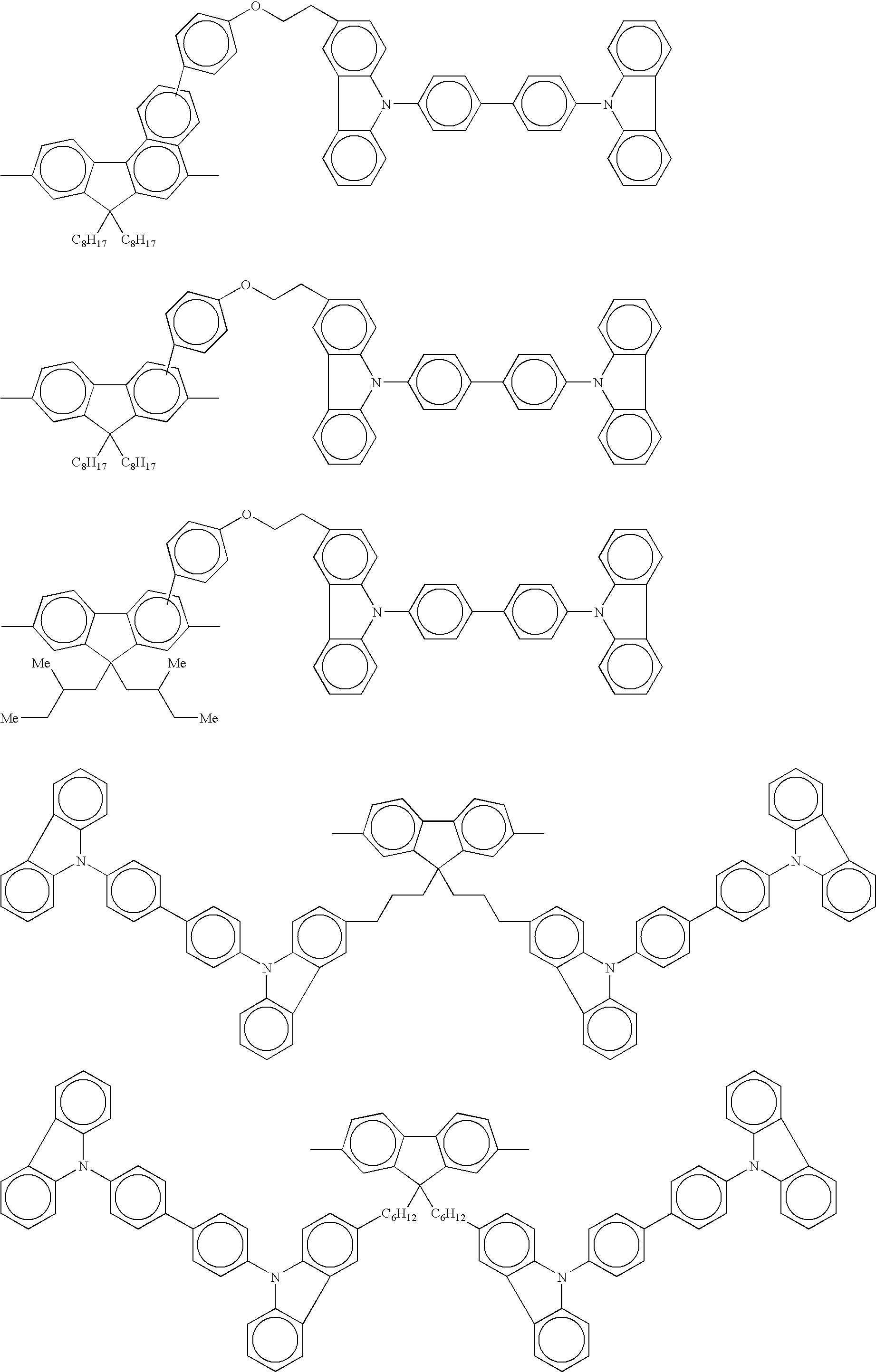

In the polymer compound of the present invention, as the repeating unit having a side chain selected from (a), (b) and (c) or the repeating unit represented by the above-described general formula (4) and having a group of the above-described general formula (2) in a random copolymer, alternating copolymer or block copolymer, a repeating unit represented by the following general formula (5) and not having a side chain selected from (a), (b) and (c) or a group of the above-described general formula (2) is preferably contained.

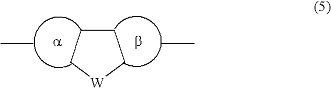

[wherein, α ring and β ring represent each independently an aromatic hydrocarbon ring optionally having a substituent, two connecting bonds are present respectively on the α ring or β ring, and W represents an atom or atom group forming a 5-membered ring or 6-membered ring together with two atoms on the α ring and two atoms on the β ring.].

In the above-described formula (5), the aromatic hydrocarbon rings represented by the α ring and β ring represent each independently a benzene ring, naphthalene ring, anthracene ring or the like. These rings optionally have a substituent.

In the above-described formula (5), W includes groups containing, for example, a carbon atom, oxygen atom, nitrogen atom or sulfur atom, and specifically mentioned are divalent groups such as —C(Q¹¹)(Q¹²)-, —C(═O)—, —O—, —S—, —SO₂—, —N(Q¹³)- and the like, and divalent groups obtained by connecting two groups selected from them. Q¹¹, Q¹² and Q¹³ represent each independently a hydrogen atom, C₁-C₁₂ alkyl group optionally having a substituent, C₆-C₂₆ aryl group optionally having a substituent or C₃-C₂₀ hetero aryl group optionally having a substituent.

Examples of the repeating unit represented by the above-described formula (5) include a fluorenediyl group, benzofluorenediyl group, dibenzofuranediyl group, dibenzothiophenediyl group, carbazolediyl group, dibenzopyranediyl group, phenanthrenediyl group and the like optionally having a substituent, and preferable is a fluorenediyl group optionally having a substituent or a benzofluorenediyl group optionally having a substituent.

The polymer compound of the present invention can be synthesized as illustrated in the present specification. That is, a monomer is synthesized having a functional group suitable for the polymerization reaction to be used instead of a connecting bond to other repeating unit carried on the repeating unit having a side chain selected from (a), (b) and (c) or the repeating unit represented by the above-described general formula (4) and having a group of the above-described general formula (2), then, the monomer is dissolved in an organic solvent if necessary, and polymerized by a polymerization method such as for example known aryl coupling or the like using an alkali, suitable catalyst and ligand, or other monomer is further added before copolymerization thereof.

Further, the polymer compound of the present invention can also be synthesized by subjecting a previously synthesized polymer main chain to halogenation, formylation, acylation and the like, then, reacting it with a side chain selected from (a), (b) and (c) having a functional group capable of reacting with such groups to form a bond, or with a precursor of a group of the above-described general formula (2).

The polymerization method according to aryl coupling is not particularly restricted, and includes, for example,

a method of polymerizing, according to the Suzuki coupling reaction, a monomer having a boric group or borate group as a functional group suitable for the above-described polymerization reaction and a monomer having a halogen atom such as bromine atom, iodine atom, chlorine atom or the like or a sulfonate group such as a trifluoromethanesulfonate group, p-toluenesulfonate group or the like as a functional group, in the presence of an inorganic base such as sodium carbonate, potassium carbonate, cesium carbonate, tripotassium phosphate, potassium fluoride and the like, an organic base such as tetrabutylammonium fluoride, tetrabutylammonium chloride, tetrabutylammonium bromide, tetraethylammonium hydroxide and the like, using a catalyst composed of a Pd or Ni complex such as palladium[tetrakis (triphenylphosphine)], [tris(dibenzylideneacetone)]dipalladium, palladium acetate, bis (triphenylphosphine)palladium dichloride, bis(cyclooctadiene)nickel or the like, and if necessary, further, a ligand such as triphenylphosphine, tri(2-methylphenyl)phosphine, tri(2-methoxyphenyl)phosphine, diphenylphosphinopropane, tri(cyclohexyl)phosphine, tri (tert-butyl)phosphine and the like;

a polymerization method according to the Yamamoto coupling reaction in which monomers having a halogen atom or a sulfonate group such as a trifluoromethane sulfonate group and the like are mutually reacted using a catalyst composed of a nickel zero-valent complex such as bis(cyclooctadiene)nickel and the like and a ligand such as bipyridyl and the like, or using a catalyst composed of a Ni complex such as [bis(diphenylphosphino)ethane]nickel dichloride, [bis(diphenylphosphino)propane]nickel dichloride and the like and, if necessary, further, a ligand such as triphenylphosphine, diphenylphosphinopropane, tri(cyclohexyl)phosphine, tri (tert-butyl)phosphine and the like, and a reducing agent such as zinc, magnesium and the like, if necessary, under dehydrated conditions;

a polymerization method according to the Kumada-Tamao coupling reaction performing polymerization by the aryl coupling reaction in which a compound having a magnesium halide group and a compound having a halogen atom are reacted using a Ni catalyst such as [bis (diphenylphosphino)ethane]nickel dichloride, [bis (diphenylphosphino)propane]nickel dichloride and the like under dehydrated conditions,

a method of polymerization with an oxidizer such as FeCl₃ and the like using a hydrogen atom as a functional group, a method of performing electrochemical oxidation polymerization, and other methods.

The reaction solvent should be selected in view of the polymerization reaction to be used, solubility of a monomer and polymer, and the like, and examples thereof include organic solvents such as tetrahydrofuran, toluene, 1,4-dioxane, dimethoxyethane, N,N-dimethylacetamide, N,N-dimethylformamide, mixed solvents composed of two or more of them, and the like, or two-phase systems of them with water.

In the Suzuki coupling reaction, organic solvents such as tetrahydrofuran, toluene, 1,4-dioxane, dimethoxyethane, N,N-dimethylacetamide, N,N-dimethylformamide, mixed solvents composed of two or more of them, and the like, or two-phase systems of them with water are preferable. The reaction solvent is, in general, preferably subjected to a deoxidation treatment for suppressing side reactions.

In the Yamamoto coupling reaction, organic solvents such as tetrahydrofuran, toluene, 1,4-dioxane, dimethoxyethane, N,N-dimethylacetamide, N,N-dimethylformamide, mixed solvents composed of two or more of them, and the like are preferably exemplified. The reaction solvent is, in general, preferably subjected to a deoxidation treatment for suppressing side reactions.

The reaction temperature is not particularly restricted providing that the reaction medium keeps liquid condition in its temperature range, and the lower limit thereof is, in general, preferably −100° C. or higher, further preferably −20° C. or higher, more preferably 0° C. or higher from the standpoint of reactivity. The upper limit thereof is preferably 200° C. or lower, more preferably 150° C. or lower, further preferably 120° C. or lower from the standpoint of stability of monomers and the polymer compound.

Among the above-described aryl coupling reactions, the Suzuki coupling reaction and the Yamamoto coupling reaction are preferable, and the Suzuki coupling reaction and the Yamamoto coupling reaction using a nickel zero-valent complex are more preferable, from the standpoint of reactivity.

More specifically, for polymerization according to the Suzuki coupling, for example, a known method described in Journal of Polymer Science: Part A: Polymer Chemistry, Vol. 39, 1533-1556 (2001) can be referred to. For polymerization according to the Yamamoto coupling, for example, a known method described in Macromolecules 1992, 25, 1214-1223 can be referred to.

The synthesis method of subjecting a previously synthesized polymer main chain to halogenation and the like, then, reacting it with a side chain having a functional group capable of reacting with such groups to form a bond, or with a precursor of a group is not particularly restricted, and for example, a method is exemplified in which bromination is carried out by a method of reacting bromine in a solution under acidic condition, then, reacting with a precursor having a boric group or borate group by the Suzuki coupling reaction.

Taking out of the polymer compound can be carried out according to known methods. For example, a polymer compound can be obtained by adding a reaction solution to a lower alcohol such as methanol and the like to deposit a precipitate and filtrating and drying the precipitate. When the purity of the polymer compound obtained by the above-described post treatment is low, purification can be performed by usual methods such as re-crystallization, continuous extraction by a soxhlet extractor, column chromatography and the like.

Next, use of the polymer compound of the present invention will be described.

The polymer compound of the present invention usually emits fluorescence or phosphorescence at solid state, and can be used as a polymer light emitting body (light emitting material of high molecular weight).

The polymer compound has an excellent charge transporting ability, and can be suitably used as a polymer light emitting device material or charge transporting material. The polymer light emitting device using the polymer compound is a high performance polymer light emitting device which can be driven at low voltage with high efficiency. Therefore, the polymer light emitting device can be preferably used for back light of a liquid crystal display, curved or plane light source for illumination, segment type display, flat panel display of dot matrix, and the like.

The polymer compound of the present invention can also be used as a coloring matter for laser, organic solar battery material, conductive thin film for organic transistor, material for electric conductive thin film such as organic semiconductor film and the like.

Further, it can be used also as a light emitting thin film material which emits fluorescence or phosphorescence.

When a solution containing the polymer compound of the present invention and a solvent is used, a light emitting layer of a light emitting device can be usually formed by a coating method. Therefore, the solution containing the polymer compound of the present invention and a solvent is preferably one containing a solvent and which is in the form of solution usually at from −40 to 40° C. and under a pressure of 1.0×10⁵ Pa.

Examples of the above-described solvent include chloroform, methylene chloride, dichloroethane, tetrahydrofuran, toluene, xylene, mesitylene, tetralin, decalin, n-butylbenzene, chlorobenzene, o-dichlorobenzene and the like. When these solvents are used, the polymer compound can be usually dissolved in an amount of 0.1 wt % or more with respect to the solvent depending on the molecular weight and the like of the polymer compound. These solvents may be used singly or in combination of two or more.

In a solution containing the polymer compound of the present invention and a solvent, the amount of the solvent is usually about from 1000 to 100000 parts by weight with respect to 100 parts by weight of the total amount of components other than the solvent in the solution.

The thin film which can be produced using the solution of the present invention is a thin film containing the polymer compound of the present invention, and examples thereof include a light emitting thin film, electric conductive thin film and organic semiconductor thin film.

The light emitting thin film of the present invention is a light emitting thin film containing the polymer compound of the present invention. The light emitting thin film is preferably a light emitting thin film showing fluorescence or phosphorescence by application of voltage from the standpoint of application of a polymer light emitting device.

The electric conductive thin film of the present invention is an electric conductive thin film containing the polymer compound of the present invention. The electric conductive thin film preferably has a surface resistance of 1 KΩ/□ or less. By doping the thin film with a Lewis acid, ionic compound and the like, electric conductivity can be enhanced. The surface resistance is more preferably 100Ω/□ or less, further preferably 10Ω/□ or less.

The organic semiconductor thin film of the present invention is an organic semiconductor thin film containing the polymer compound of the present invention.

In the organic semiconductor thin film, either larger one of electron mobility or hole mobility is preferably 10⁻⁵ cm²/V/second or more. More preferably, it is 10⁻³ cm²/V/second or more, further preferably 10⁻¹ cm²/V/second or more.

An organic transistor can be obtained by forming the organic semiconductor thin film on a Si substrate having a gate electrode and an insulation film made of SiO₂ and the like formed thereon, and forming a drain electrode and a source electrode with Au and the like.

The polymer light emitting device of the present invention contains the polymer compound of the present invention, and more specifically, has electrodes composed of an anode and a cathode, and a light emitting layer containing the polymer compound provided between the electrodes. This polymer light emitting device may be manufactured by any method, and for example, can be manufactured from a solution containing the polymer compound of the present invention and a solvent described above.

The polymer light emitting device of the present invention includes also, for example, (1) a polymer light emitting device having an electron transporting layer provided between a cathode and a light emitting layer, (2) a polymer light emitting device having a hole transporting layer provided between an anode and a light emitting layer, (3) a polymer light emitting device having an electron transporting layer provided between a cathode and a light emitting layer and a hole transporting layer provided between an anode and a light emitting layer, and the like.

Examples of the structure of the polymer light emitting device of the present invention include, for example, the following a) to d).

a) anode/light emitting layer/cathode
b) anode/hole transporting layer/light emitting layer/cathode
c) anode/light emitting layer/electron transporting layer/cathode
d) anode/hole transporting layer/light emitting layer/electron transporting layer/cathode
(here,/means adjacent lamination of layers, being applicable also in the followings)

The light emitting layer means a layer having a function of light emission. The hole transporting layer means a layer having a function of transporting holes. The electron transporting layer means a layer having a function of transporting electrons. The hole transporting layer and the electron transporting layer are generically called a charge transporting layer. Two or more light emitting layers, two or more hole transporting layers and two or more electron transporting layers may be present each individually.

Among hole transporting layers and electron transporting layers provided adjacent to an electrode, those having a function of improving charge injection efficiency from an electrode and having an effect of lowering driving voltage of a device are generally called particularly a hole injection layer and electron injection layer, respectively, (hereinafter, these two layers are generically called “charge injection layer” in some cases).

Further, for improvement in close adherence with an electrode and improving charge injection from an electrode, the above-described charge injection layer of an insulation layer having a thickness of 2 nm or less may be provided adjacent to an electrode, and for improvement in close adherence with an interface and mixing prevention and the like, a thin buffer layer may also be inserted into the interface of a charge transporting layer and a light emitting layer.

The kind, order and number of layers to be laminated, and the thickness of each layer may be appropriately controlled and selected in view of light emission efficiency and device lifetime and the like.

When the light emitting layer is formed from, for example, a solution containing the polymer compound of the present invention, the solvent may be removed only by drying after coating of this solution, and even if a charge transporting material and light emitting material are mixed into a solution containing the polymer compound, a similar manner can be applied, meaning a significant advantage in production.

In film formation from a solution, coating methods such as, for example, a spin coat method, casting method, micro gravure coat method, gravure coat method, bar coat method, roll coat method, wire bar coat method, dip coat method, spray coat method, screen printing method, flexo printing method, offset printing method, inkjet printing method and the like can be used.

Regarding the thickness of the light emitting layer, the optimum value varies depending on a material to be used, and it may be advantageously selected so as to give suitable driving voltage and light emission efficiency, and it is, for example, 1 nm to 1 μm, preferably 2 nm to 600 nm, further preferably 5 nm to 400 nm.

In the polymer light emitting device of the present invention, light emitting materials other than the above-described polymer compound may be mixed into a light emitting layer. Such a light emitting layer containing light emitting materials other than the polymer compound may also be laminated to a light emitting layer containing the above-described polymer compound.

As the above-described light emitting material, known materials can be used. In the case of a lower molecular weight compound, for example, naphthalene derivatives, anthracene and its derivatives, perylene and its derivatives, and polymethine, xanthene, coumarin and cyanine coloring matters, metal complexes of 8-hydrozyquinoline, metal complexes of 8-hydrozyquinoline derivatives, triplet light emitting complexes, aromatic amines, tetraphenylcyclopentadiene and its derivatives, tetraphenylbutadiene and its derivatives, and the like can be used. Specifically, known compounds such as those described in, for example, JP-A Nos. 57-51781, 59-194393, and the like can be used.

The triplet light emitting complex includes, for example, Ir(ppy)₃, Btp₂Ir(acac) containing iridium as a central metal, PtOEP containing platinum as a central metal, Eu(TTA)3phen containing europium as a central metal, and the like.

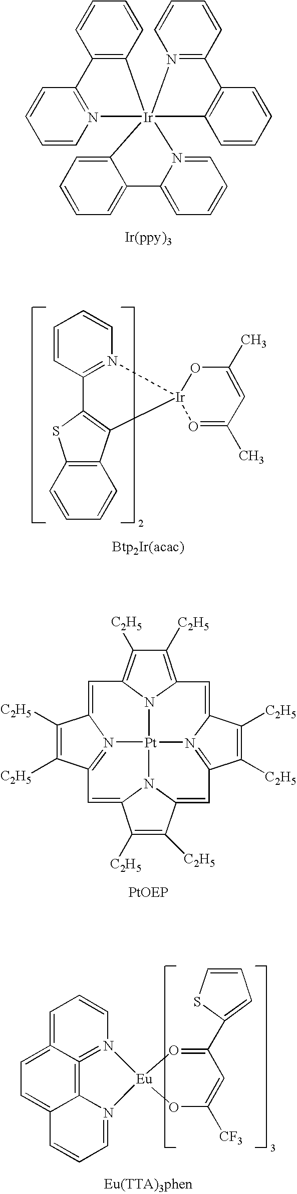

The triplet light emitting complex is described, for example, in Nature, (1998), 395, 151, Appl. Phys. Lett. (1999), 75(1), 4, Proc. SPIE-Int. Soc. Opt. Eng. (2001), 4105 (Organic Light-Emitting Materials and Devices IV), 119, J. Am. Chem. Soc., (2001), 123, 4304, Appl. Phys. Lett., (1997), 71(18), 2596, Syn. Met., (1998), 94(1), 103, Syn. Met., (1999), 99(2), 1361, Adv. Mater., (1999), 11(10), 852, Jpn. J. Appl. Phys., 34, 1883 (1995), and the like.

When the polymer light emitting device of the present invention contains a hole transporting layer, a hole transporting material (low molecular weight or high molecular weight) is used in the hole transporting layer. Examples of the hole transporting material include polyvinylcarbazole and its derivatives, polysilane and its derivatives, polysiloxane derivatives having an aromatic amine on the side chain or main chain, pyrazoline derivatives, arylamine derivatives, stilbene derivatives, triphenyldiamine derivatives, polyaniline and its derivatives, polythiophene and its derivatives, polypyrrole and its derivatives poly(p-phenylenevinylene) and its derivatives, poly(2,5-thienylenevinylene) and its derivatives, and the like. Specific examples of the hole transporting material are those described in JP-A Nos. 63-70257, 63-175860, 2-135359, 2-135361, 2-209988, 3-37992 and 3-152184, and the like.

Among them, preferable as the hole transporting material are macromolecular hole transporting materials such as polyvinylcarbazole and its derivatives, polysilane and its derivatives, polysiloxane derivatives having an aromatic amine compound residue on the side chain or main chain, polyaniline and its derivatives, polythiophene and its derivatives, poly(p-phenylenevinylene) and its derivatives, poly(2,5-thienylenevinylene) and its derivatives, and the like, and further preferable are polyvinylcarbazole and its derivatives, polsilane and its derivatives, and polysiloxane derivatives having an aromatic amine on the side chain or main chain. A hole transporting material of low molecular weight is preferably dispersed in a polymer binder for use.

Polyvinylcarbazole and its derivative can be obtained, for example, from a vinyl monomer by cation polymerization or radical polymerization.

Examples of the polysilane and its derivative, include compounds described in Chem. Rev., vol. 89, p. 1359 (1989), GB Patent No. 2300196 publication, and the like. Also as the synthesis method, methods described in them can be used, and particularly, the Kipping method is suitably used.

The film formation method of a hole transporting layer is not particularly restricted, and in the case of a hole transporting material of low molecular weight, a method of film formation from a mixed solution with the above-described polymer binder is illustrated, and in the case of a hole transporting material of high molecular weight, a method of film formation from a solution is illustrated.

As the solvent used for film formation from a solution, those which can dissolve a hole transporting material and/or polymer binder are not particularly restricted. Examples of the solvent include chlorine-based solvents such as chloroform, methylene chloride, dichloroethane and the like, ether solvents such as tetrahydrofuran and the like, aromatic hydrocarbon solvents such as toluene, xylene and the like, ketone solvents such as acetone, methyl ethyl ketone and the like, ester solvents such as ethyl acetate, butyl acetate, ethylcellosolve acetate and the like.

As the method for film formation from a solution, there can be used coating methods such as a spin coat method, casting method, micro gravure coat method, gravure coat method, bar coat method, roll coat method, wire bar coat method, dip coat method, spray coat method, screen printing method, flexo printing method, offset printing method, inkjet printing method and the like.

As the above-described polymer binder, those not extremely disturbing charge transportation are preferable, and those showing no intense absorption for visible light are suitably used. Examples of the polymer binder include polycarbonate, polyacrylate, polymethyl acrylate, polymethyl methacrylate, polystyrene, polyvinyl chloride, polysiloxane and the like.

Regarding the thickness of a hole transporting layer, the optimum value varies with a material to be used, and it may be advantageously adjusted so that the driving voltage and light emission efficiency become optimum, and a thickness at least causing no formation of pin holes is necessary, and when the thickness is too large, the driving voltage of a device increases undesirably. Therefore, the thickness of the hole transporting layer is, for example, from 1 nm to 1 μm, preferably 2 nm to 500 nm, further preferably 5 nm to 200 nm.

The polymer light emitting device of the present invention can attain further higher light emission efficiency by using a hole transporting layer of polyamine having a constituent unit particularly derived from an aromatic amine.

When the polymer light emitting device of the present invention has an electron transporting layer, an electron transporting material (low molecular weight or high molecular weight) is used in the electron transporting layer. Known materials can be used as the electron transporting material, and exemplified are oxadiazole derivatives, anthraquinodimethane and its derivatives, benzoquinone and its derivatives, naphthoquinone and its derivatives, anthraquinone and its derivatives, tetracyanoanthraquinodimethane and its derivatives, fluorenone derivatives, diphenyldicyanoethylene and its derivatives, diphenoquinone derivatives, metal complexes of 8-hydroxyquinoline, metal complexes of 8-hydroxyquinoline derivatives, polyquinoline and its derivatives, polyquinoxaline and its derivatives, polyfluorene and its derivatives, and the like.

Specific examples of the electron transporting material include those described in JP-A Nos. 63-70257, 63-175860, 2-135359, 2-135361, 2-209988, 3-37992, 3-152184, and the like.

Of them, oxadiazole derivatives, benzoquinone and its derivatives, anthraquinone and its derivatives, metal complexes of 8-hydroxyquinoline, metal complexes of 8-hydroxyquinoline derivatives, polyquinoline and its derivatives, polyquinoxaline and its derivatives, polyfluorene and its derivatives are preferable, and 2-(4-biphenylyl)-5-(4-t-butylphenyl)-1,3,4-oxadiazole, benzouqinone, anthraquinone, tris(8-quinolinol)aluminum and polyquinoline are further preferable.

The film formation method of an electron transporting layer is not particularly restricted, and in the case of an electron transporting material of low molecular weight, exemplified are a vacuum vapor-deposition method from powder, film formation methods from solution or melted conditions, and in the case of an electron transporting material of high molecular weight, film formation methods from solution or melted condition are illustrated, respectively. In film formation from solution or melted condition, the polymer binder may be used together.

As the solvent to be used in film formation from a solution, those which can dissolve or uniformly disperse an electron transporting material and/or polymer binder are preferable. Specifically, those illustrated as the solvent to be used in film formation from a solution of a hole transporting layer, in the above-described section of the hole transporting layer, are mentioned. These solvents may be used singly or in combination of two or more.

As the film formation method from solution or melted condition, those illustrated as the film formation method from a solution of a hole transporting layer, in the above-described section of the hole transporting layer, are mentioned.

Regarding the thickness of an electron transporting layer, the optimum value varies depending on a material to be used, and it may be advantageously selected so that the driving voltage and light emission efficiency become optimum, and a thickness at least causing no formation of pin holes is necessary, and when the thickness is too large, the driving voltage of a device increases undesirably. Therefore, the thickness of the electron transporting layer is usually 1 nm to 1 μm, preferably 2 nm to 500 nm, further preferably 5 nm to 200 nm.

For film formation from solution or melted condition, there can be used coating methods such as a spin coat method, casting method, micro gravure coat method, gravure coat method, bar coat method, roll coat method, wire bar coat method, dip coat method, spray coat method, screen printing method, flexo printing method, offset printing method, inkjet printing method and the like.

As the above-described polymer binder, those not extremely disturbing charge transportation are preferable, and those showing no intense absorption for visible light are suitably used. Examples of the polymer binder include poly(N-vinylcarbazole), polyaniline and derivatives thereof, polythiophene and derivatives thereof, poly(p-phenylenevinylene) and derivatives thereof, poly(2,5-thienylenevinylene) and derivatives thereof, polycarbonate, polyacrylate, polymethyl acrylate, polymethyl methacrylate, polystyrene, polyvinyl chloride, polysiloxane or the like.

Regarding the thickness of an electron transporting layer, the optimum value varies with a material to be used, and it may be advantageously selected so that the driving voltage and light emission efficiency become optimum, and a thickness at least causing no formation of pin holes is necessary, and when the thickness is too large, the driving voltage of a device increases undesirably. Therefore, the thickness of the electron transporting layer is usually from 1 nm to 1 μm, preferably 2 nm to 500 nm, further preferably 5 nm to 200 nm.

As the material of the anode, an electric conductive metal oxide film, semi-transparent metal thin film and the like are used. Specifically, films (NESA and the like) formed using electric conductive glass composed of indium oxide, zinc oxide, tin oxide, and composite thereof: indium.tin.oxide (ITO), indium.zinc.oxide and the like, and gold, platinum, silver, copper and the like are used, and ITO, indium.zinc.oxide and tin oxide are preferable. As the anode manufacturing method, a vacuum vapor-deposition method, sputtering method, ion plating method, plating method and the like are mentioned. As the anode, organic transparent electric conductive films made of polyaniline or its derivative, polythiophene or its derivative, and the like may be used.

The thickness of an anode can be appropriately adjusted in view of light transmission and electric conductivity, and it is usually from 10 nm to 10 μm, preferably 20 nm to 1 μm, further preferably 50 nm to 500 nm.

For making electric charge injection easier, a layer made of a phthalocyanine derivative, electric conductive polymer, carbon and the like, or a layer having an average thickness of 2 nm or less made of a metal oxide, metal fluoride, organic insulation material and the like, may be provided on an anode.

As the material of a cathode, materials of small work function are preferable. For example, metals such as lithium, sodium, potassium, rubidium, cesium, beryllium, magnesium, calcium, strontium, barium, aluminum, scandium, vanadium, zinc, yttrium, indium, cerium, samarium, europium, terbium, ytterbium and the like, alloys of two or more of them, or alloys made of at least one of them and at least one of gold, silver, platinum, copper, manganese, titanium, cobalt, nickel, tungsten and tin, graphite or graphite interlaminar compounds and the like are used. Examples of the alloy include magnesium-silver alloy, magnesium-indium alloy, magnesium-aluminum alloy, indium-silver alloy, lithium-aluminum alloy, lithium-magnesium alloy, lithium-indium alloy, calcium-aluminum alloy and the like. The cathode may take a laminated structure including two or more layers.

The thickness of a cathode can be appropriately adjusted in view of electric conductivity and durability, and it is, for example, from 10 nm to 10 μm, preferably 20 nm to 1 μm, further preferably 50 nm to 500 nm.

As the cathode manufacturing method, a vacuum vapor-deposition method, sputtering method, lamination method of thermally press-binding a metal thin film, and the like are used. A layer made of an electric conductive polymer, or a layer having an average thickness of 2 nm or less made of a metal oxide, metal fluoride, organic insulation material and the like, may be provided between a cathode and an organic substance layer, and after manufacturing a cathode, a protective layer for protecting the polymer light emitting diode may be installed. For use of the polymer light emitting diode stably for a long period of time, it is preferable to install a protective layer and/or protective cover, for protecting a device from outside.

As the protective layer, a polymer compound, metal oxide, metal fluoride, metal boride and the like can be used. As the protective cover, a glass plate, and a plastic plate having a surface which has been subjected to low water permeation treatment, and the like can be used, and a method of pasting the cover to a device substrate with a thermosetting resin or photo-curable resin to attain sealing is suitably used. When a space is kept using a spacer, blemishing of a device can be prevented easily. If an inert gas such as nitrogen, argon and the like is filled in this space, oxidation of a cathode can be prevented, further, by placing a drying agent such as barium oxide and the like in this space, it becomes easier to suppress moisture adsorbed in a production process from imparting damage to the device. It is preferable to adopt any one or more strategies among these methods.

In the present invention, the polymer light emitting device carrying a charge injection layer provided includes, for example, a polymer light emitting device having a charge injection layer provided adjacent to a cathode and a polymer light emitting device having a charge injection layer provided adjacent to an anode. Specifically, the following structures e) to p) are mentioned.

e) anode/charge injection layer/light emitting layer/cathode
f) anode/light emitting layer/charge injection layer/cathode
g) anode/charge injection layer/light emitting layer/charge injection layer/cathode
h) anode/charge injection layer/hole transporting layer/light emitting layer/cathode
i) anode/hole transporting layer/light emitting layer/charge injection layer/cathode
j) anode/charge injection layer/hole transporting layer/light emitting layer/charge injection layer/cathode
k) anode/charge injection layer/light emitting layer/electron transporting layer/cathode
l) anode/light emitting layer/electron transporting layer/charge injection layer/cathode
m) anode/charge injection layer/light emitting layer/electron transporting layer/charge injection layer/cathode
n) anode/charge injection layer/hole transporting layer/light emitting layer/electron transporting layer/cathode
o) anode/hole transporting layer/light emitting layer/electron transporting layer/charge injection layer/cathode
p) anode/charge injection layer/hole transporting layer/light emitting layer/electron transporting layer/charge injection layer/cathode

Specific examples of the charge injection layer include a layer containing an electric conductive polymer, a layer provided between an anode and a hole transporting layer and containing a material having ionization potential of a value between an anode material and a hole transporting material contained in a hole transporting layer, a layer provided between a cathode and an electron transporting layer and containing a material having electron affinity of a value between a cathode material and an electron transporting material contained in an electron transporting layer, and the like.

When the charge injection layer contains an electric conductive polymer, electric conductivity of the electric conductive polymer is preferably 10⁻⁵ S/cm or more and 10³ or less, and for decreasing leak current between light emission picture elements, more preferably 10⁻⁵ S/cm or more and 10² or less, further preferably 10⁻⁵ S/cm or more and 10¹ or less. Usually, for controlling the electric conductivity of the electric conductive polymer to 10⁻⁵ S/cm or more and 10³ or less, the electric conductive polymer is doped with a suitable amount of ions.

As the kind of ions to be doped, an anion is used in a hole injection layer and a cation is used in an electron injection layer. Examples of the anion include a polystyrenesulfonic ion, alkylbenzenesulfonic ion, camphorsulfonic ion and the like. Examples of the cation include a lithium ion, sodium ion, potassium ion, tetrabutylammonium ion and the like.

The thickness of the charge injection layer is usually from 1 nm to 100 nm, preferably 2 nm to 50 nm.

The material to be used in the charge injection layer may be appropriately selected depending on a relation with materials of an electrode and an adjacent layer, and examples thereof include polyaniline and its derivatives, polythiophene and its derivatives, polypyrrole and its derivatives, polyphenylenevinylene and its derivatives, polythienylenevinylene and its derivatives, polyquinoxaline and its derivatives, electric conductive polymers such as polymers containing an aromatic amine structure on the main chain or side chain, metal phthalocyanines (copper phthalocyanine and the like), carbon and the like.

An insulation layer having a thickness of 2 nm or less has a function of making charge injection easier. The material of the insulation layer includes a metal fluoride, metal oxide, organic insulating material and the like.

As the polymer light emitting device carrying an insulation layer having a thickness of 2 nm or less provided thereon, there are mentioned a polymer light emitting device in which an insulation layer having a thickness of 2 nm or less is provided adjacent to a cathode, and a polymer light emitting device in which an insulation layer having a thickness of 2 nm or less is provided adjacent to an anode. Specifically, the following structures q) to ab) are mentioned, for example.

q) anode/insulation layer having a thickness of 2 nm or less/light emitting layer/cathode
r) anode/light emitting layer/insulation layer having a thickness of 2 nm or less/cathode
s) anode/insulation layer having a thickness of 2 nm or less/light emitting layer/insulation layer having a thickness of 2 nm or less/cathode
t) anode/insulation layer having a thickness of 2 nm or less/hole transporting layer/light emitting layer/cathode
u) anode/hole transporting layer/light emitting layer/insulation layer having a thickness of 2 nm or less/cathode
v) anode/insulation layer having a thickness of 2 nm or less/hole transporting layer/light emitting layer/insulation layer having a thickness of 2 nm or less/cathode
w) anode/insulation layer having a thickness of 2 nm or less/light emitting layer/electron transporting layer/cathode
x) anode/light emitting layer/electron transporting layer/insulation layer having a thickness of 2 nm or less/cathode
y) anode/insulation layer having a thickness of 2 nm or less/light emitting layer/electron transporting layer/insulation layer having a thickness of 2 nm or less/cathode
z) anode/insulation layer having a thickness of 2 nm or less/hole transporting layer/light emitting layer/electron transporting layer/cathode
aa) anode/hole transporting layer/light emitting layer/electron transporting layer/insulation layer having a thickness of 2 nm or less/cathode
ab) anode/insulation layer having a thickness of 2 nm or less/hole transporting layer/light emitting layer/electron transporting layer/insulation layer having a thickness of 2 nm or less/cathode

The polymer light emitting device of the present invention is usually formed on a substrate. This substrate may advantageously be that forming an electrode and which does not change in forming a layer of an organic substance. Examples of the substrate material include glass, plastic, polymer film, silicon and the like. In the case of an opaque substrate, it is preferable that the opposite electrode (namely, electrode remote from substrate) is transparent or semi-transparent. Usually, at least one of an anode and a cathode carried on the polymer light emitting device of the present invention is transparent or semi-transparent. It is preferable that the anode side is transparent or semi-transparent.

The polymer compound and polymer light emitting device of the present invention can be used in, for example, sheet light sources (for example, illumination and the like) such as a curved light source, plane light source and the like; and displays such as segment displays (for example, display of segment type, and the like), dot matrix displays (for example, dot matrix flat display and the like), liquid crystal displays (for example, liquid crystal display, liquid crystal display back light, and the like) and the like.

For obtaining light emission in the form of sheet using the polymer light emitting device of the present invention, it may be advantages to place a sheet anode and a sheet cathode so as to overlap. For obtaining light emission in the form of pattern, there are a method in which a mask having a window in the form of pattern is placed on the surface of the sheet light emitting device, a method in which an organic substance layer in non-light emitting parts is formed with extremely large thickness to give substantially no light emission, a method in which either anode or cathode, or both electrodes are formed in the form pattern. By forming a pattern by any of these methods, and placing several electrodes so that on/off is independently possible, a display of segment type is obtained which can display digits, letters, simple marks and the like. Further, for providing a dot matrix device, it may be permissible that both an anode and a cathode are formed in the form of stripe, and placed so as to cross. By using a method in which several polymer fluorescent bodies showing different emission colors are painted separately or a method in which a color filter or a fluorescence conversion filter is used, partial color display and multi-color display are made possible. In the case of a dot matrix device, passive driving is possible, and active driving may be carried out in combination with TFT and the like. These displays can be used as a display of a computer, television, portable terminal, cellular telephone, car navigation, view finder of video camera, and the like.

The sheet light emitting device is of self emitting and thin type, and can be suitably used as a sheet light source for back light of a liquid crystal display, or as a sheet light source for illumination. If a flexible substrate is used, it can also be used as a curved light source or display.

Examples will be shown below for illustrating the present invention further in detail, but the present invention is not limited to them.

### (Number-Average Molecular Weight and Weight-Average Molecular Weight)

Here, as the number-average molecular weight (Mn) and the weight-average molecular weight (Mw), a number-average molecular weight (Mn) and a weight-average molecular weight (Mw) in terms of polystyrene were measured by GPC.

### <GPC Measurement Method>

Tetrahydrofuran was used as a developing solvent and allowed to flow at a flow rate of 0.5 mL/min and measurement was performed at 40° C., using a column composed of three pieces of TSKgel Super HM-H (manufactured by Tosoh Corp.) connected serially, by GPC (HLC-8220 GPC manufactured by Tosoh Corp.). A differential refractive index detector was used as a detector.

### SYNTHESIS EXAMPLE 1

### Synthesis of Compound E, Compound F

Synthesis of Compound A

Under an inert atmosphere, into a 300 ml three-necked flask was charged 5.00 g (29 mmol) of 1-naphthaleneboronic acid, 6.46 g (35 mmol) of 2-bromobenzaldehyde, 10.0 g (73 mmol) of potassium carbonate, 36 ml of toluene, and 36 ml of ion exchange water, and the mixture was bubbled with 25 argon for 20 minutes while stirring at room temperature. Next, 16.8 mg (0.15 mmol) of tetrakis (triphenylphosphine)palladium was added, and further bubbled with argon for 10 minutes while stirring at room temperature. The mixture was heated up to 100° C. and reacted for 25 hours. After cooling to room temperature, the organic layer was extracted with toluene, and the resultant organic layer was dried over sodium sulfate, then, the solvent was distilled off. Thus obtained compound was purified by a silica gel column using a mixed solvent of toluene:cyclohexane=1:2 (volume ratio) as a developing solvent, to obtain 5.18 g (yield: 86%) of Compound A of the following formula:

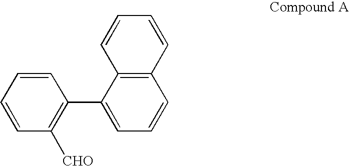

as white crystal.

¹H-NMR (300 MHz/CDCl₃):

δ7.39 to 7.62 (m, 5H), 7.70 (m, 2H), 7.94 (d, 2H), 8.12 (dd, 2H), 9.63 (s, 1H)

MS (APCI(+)): (M+H)⁺ 233

Synthesis of Compound B

Under an inert atmosphere, into a 300 ml three-necked flask was charged 8.00 g (34.4 mmol) of Compound A synthesized by the same manner as described above and 46 ml of dehydrated THF, and the mixture was cooled down to −78° C. Next, 52 ml of n-octylmagnesium bromide (1.0 mol/l THF solution) was dropped over a period of 30 minutes. After completion of dropping, the temperature was raised to 0° C., and the mixture was stirred for 1 hour, then, heated up to room temperature and stirred for 45 minutes. 20 ml of 1 N hydrochloric acid was added while cooling in an ice bath, to stop the reaction, and the organic layer was extracted with ethyl acetate and the resultant organic layer was dried over sodium sulfate. The solvent was distilled off, then, purification was performed by a silica gel column using a mixed solvent of toluene:hexane=10:1 (volume ratio) as a developing solvent, to obtain 7.64 g (yield: 64%) of Compound B of the following formula:

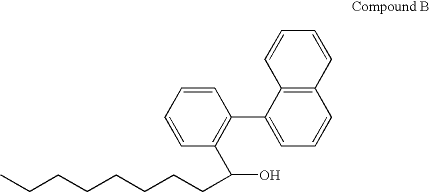

as pale yellow oil. In HPLC (high performance liquid chromatography) measurement, two peaks were observed, however, in LC/MS (liquid chromatography/mass spectrometry) measurement, identical mass numbers were observed, leading to an estimation of a mixture of isomers.

Synthesis of Compound C

Under an inert atmosphere, into a 500 ml three-necked flask was charged 5.00 g (14.4 mmol) of Compound B(isomer mixture) and 74 ml of dehydrated dichloromethane, and dissolved by stirring at room temperature. Next, an etherate complex of boron trifluoride was dropped at room temperature over a period of 1 hour, and after completion of dropping, the mixture was stirred at room temperature for 4 hours. 125 ml of ethanol was slowly added while stirring, and when heat generation stopped, the organic layer was extracted with chloroform and the resultant organic layer was washed with water twice, and dried over magnesium sulfate. After distilling off the solvent, purification was performed by a silica gel column using hexane as a developing solvent, to obtain 3.22 g (yield: 68%) of Compound C of the following formula

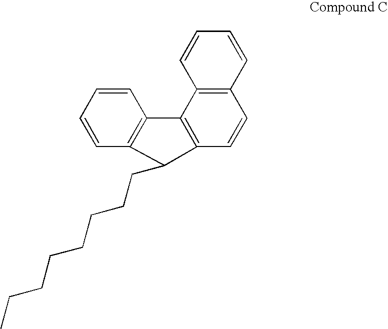

as colorless oil.

¹H-NMR (300 MHz/CDCl₃):

δ0.90 (t, 3H), 1.03 to 1.26 (m, 14H), 2.13 (m, 2H), 4.05 (t, 1H), 7.35 (dd, 1H), 7.46 to 7.50 (m, 2H), 7.59 to 7.65 (m, 3H), 7.82 (d, 1H), 7.94 (d, 1H), 8.35 (d, 1H), 8.75 (d, 1H)

MS (APCI(+)): (M+H)⁺ 329

Synthesis of Compound D

Under an inert atmosphere, into a 200 ml three-necked flask was charged 20 ml of ion exchange water, and 18.9 g (0.47 mol) of sodium hydroxide was added portionwise while stirring, to cause dissolution. The resultant aqueous solution was cooled down to room temperature, then, 20 ml of toluene, 5.17 g (15.7 mmol) of Compound C synthesized by the same manner as described above and 1.52 g (4.72 mmol) of tributylammonium bromide were added and the mixture was heated up to 50° C. n-octyl bromide was dropped, and after completion of dropping, the mixture was reacted at 50° C. for 9 hours. After completion of the reaction, the organic layer was extracted with toluene and the resultant organic layer was washed with water twice, and dried over sodium sulfate. After distilling off the solvent, purification was performed by a silica gel column using hexane as a developing solvent, to obtain 5.13 g (yield: 74%) of Compound D of the following formula:

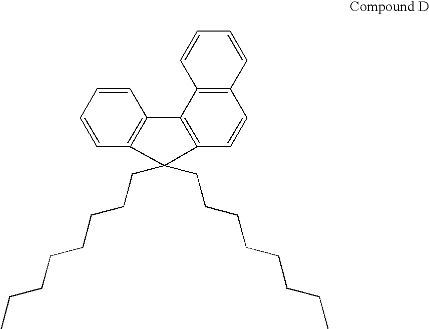

as yellow oil.

¹H-NMR (300 MHz/CDCl₃):

δ0.52 (m, 2H), 0.79 (t, 6H), 1.00 to 1.20 (m, 22H), 2.05 (t, 4H), 7.34 (d, 1H), 7.40 to 7.53 (m, 2H), 7.63 (m, 3H), 7.83 (d, 1H), 7.94 (d, 1H), 8.31 (d, 1H), 8.75 (d, 1H)

MS (APCI(+)): (M+H)⁺ 441

Synthesis of Compound E

Under an air atmosphere, into a 50 ml three-necked flask was charged 4.00 g (9.08 mmol) of Compound D and 57 ml of a mixed solvent of acetic acid:dichloromethane=1:1 (volume ratio), and the mixture was stirred at room temperature, to cause dissolution. Next, 7.79 g (20.0 mmol) of benzyltrimethylammonium tribromide was added, and zinc chloride was added while stirring until completion dissolution of benzyltrimethylammonium tribromide. The mixture was stirred at room temperature for 20 hours, then, 10 ml of a 5 wt % sodium hydrogen sulfite aqueous solution was added to terminate the reaction, and the organic layer was extracted with chloroform and the resultant organic layer was washed twice with a potassium carbonate aqueous solution, and dried over sodium sulfate. Purification was performed twice by flush column chromatography using hexane as a developing solvent, then, re-crystallization was carried out with a mixed solvent of ethanol:hexane=1:1 (volume ratio), then, re-crystallization was carried out with a mixed solvent of ethanol:hexane=10:1 (volume ratio), to obtain 4.13 g (yield: 76%) of Compound E of the following formula:

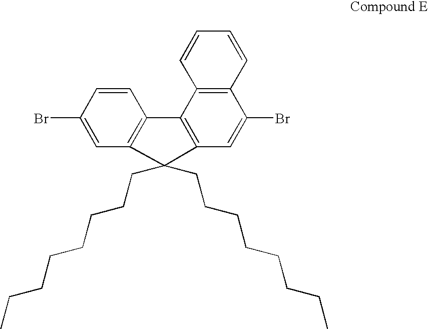

as white crystal.

¹H-NMR (300 MHz/CDCl₃):

δ0.60 (m, 4H), 0.91 (t, 6H), 1.01 to 1.38 (m, 20H), 2.09 (t, 4H), 7.62 to 7.75 (m, 4H), 7.89 (s, 1H), 8.20 (d, 1H), 8.47 (d, 1H), 8.72 (d, 1H)

MS (APPI(+)):M⁺ 596

Synthesis of Compound F

A 100 ml four-necked round bottomed flask was purged with an argon gas, then, Compound E (3.2 g, 5.3 mmol), bispina colato diboron (3.8 g, 14.8 mmol), PdCl₂ (dppf) (0.39 g, 0.45 mmol), bis(diphenylphosphinoferrocene (0.27 g, 0.45 mmol and potassium acetate (3.1 g, 32 mmol) were charged, and 45 ml of dehydrated dioxane was added. Under an argon atmosphere, the mixture was heated up to 100° C. and reacted for 36 hours. After allowing to cool, 2 g of celite was pre-coated and filtration was performed and concentrated to obtain black liquid. This black liquid was mixed with 50 g of hexane, and thus obtained mixed solution was filtrated with pre-coating with 5 g of radiolite, and colored components were removed by activated carbon, to obtain 37 g of pale yellow liquid. To this pale yellow liquid was added 6 g of ethyl acetate, 12 g of dehydrated methanol and 2 g of hexane, and crystallization was caused by immersing in a dry ice-methanol bath, and the crystal was filtrated and dried, to obtain 2.1 g of Compound F of the following formula:

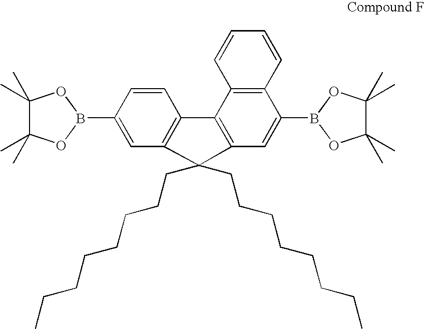

as colorless crystal.

### SYNTHESIS EXAMPLE 2

### Synthesis of Polymer 1

Under an argon atmosphere, into a 1 L three-necked flask connected to Dimroth was added 17.0 g (28.4 mmol) of Compound E synthesized by the same manner as described above, 19.4 g (28.0 mmol) of Compound F synthesized by the same manner as described above, and 311 ml of toluene, then, the gas in the vessel was purged with nitrogen by bubbling with a nitrogen gas. After heating up to 45° C., 19 mg of palladium acetate and 118 mg of tri(o-methoxyphenyl)phosphine were added and stirred at 45° C. for 5 minutes, then, 25.9 ml of a 33 wt % bis(tetraethylammonium) carbonate aqueous solution was added and stirred at 114° C. for 24 hours. Next, 5.27 g (30.8 mmol) of 4-bromotoluene was added and the mixture was stirred at 114° C. for 1 hour, and further, 5.48 g (30.8 mmol) of 4-t-butylphenylboronic acid was added and the mixture was stirred at 114° C. for 1 hour. The mixture was cooled down to 65° C., and washed with a 5 wt % sodium diethyldithiocarbamate aqueous solution twice, 2 N hydrochloric acid twice, 10 wt % sodium acetate aqueous solution twice, and water six-times, then, the resultant organic layer was filtrated through celite, and concentrated under reduced pressure, and dropped into methanol to cause precipitation of the polymer. The resultant precipitate was filtrated, and dried under reduced pressure to obtain a powder which was, then, dissolved again in toluene and the solution was dropped into methanol to cause precipitation, and this procedure was repeated twice. Thus obtained precipitate was dried under reduced pressure, to obtain 22.4 g (yield: 90.3%) of a polymer having a constituent unit of the following general formula (estimated from charged raw materials) (hereinafter, referred to as “Polymer 1”).

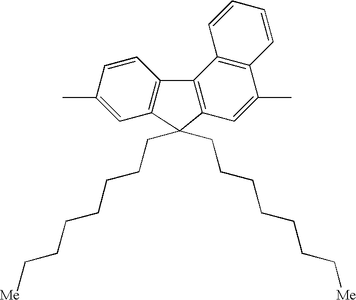

The polystyrene-reduced number-average molecular weight Mn was 7.9×10⁴, and the polystyrene-reduced weight-average molecular weight Mw was 1.7×10⁵.

### SYNTHESIS EXAMPLE 3

### Synthesis of Polymer 2

### Bromination of Polymer 1

Under an argon gas atmosphere, into a 100 ml flask was charged Polymer 1 (1.0 g, 2.28 mmol in terms of benzofluorene repeating unit) and 50 ml of chloroform and dissolved by stirring at room temperature, then, 3.5 ml of trifluoroacetic acid and 91 μL of bromine (1.78 mmol, 78 mol % with respect to benzofluorene unit) were charged sequentially, and stirred under light shielding for 6 hours. The reaction mass was dropped into 250 mL of methanol while stirring, to cause precipitation. The resultant precipitate was filtrated and washed with methanol, and dried under reduced pressure to obtain 1.09 g of a polymer. This polymer was charged into a 100 mL flask under an argon atmosphere, and 50 mL of chloroform was charged, and stirred at room temperature to cause dissolution thereof, then, 3.4 ml of trifluoroacetic acid and 41 μL of bromine (0.80 mmol, 36 mol % with respect to benzofluorene unit) were charged sequentially, and stirred under light shielding for 17 hours. The reaction mass was dropped into 250 mL of methanol while stirring, to cause precipitation. The resultant the precipitate was filtrated, washed with methanol, and dried under reduced pressure to obtain 1.08 g of a polymer. The resultant polymer is called Polymer 2. The resultant Polymer 2 had a polystyrene-reduced number-average molecular weight Mn of 7.4×10⁴, a polystyrene-reduced weight-average molecular weight Mw of 1.6×10⁵, and a degree of dispersion Mw/Mn of 2.2.

From the results of element analysis, the ratio of a repeating unit having a Br group (formula P-2) and a repeating unit containing no Br group (formula P-1) corresponds to (P-1)/(P-2)=35/65, and (all benzofluorene repeating units)/Br group=61/39.

element analysis measured value: C 80.20%; H 8.40%; N <0.3%; Br 10.56%.

element analysis calculated value: C 80.92%; H 8.51%; N 0%; Br 10.56%. (calculated value at (P-1)/(P-2)=35/65)

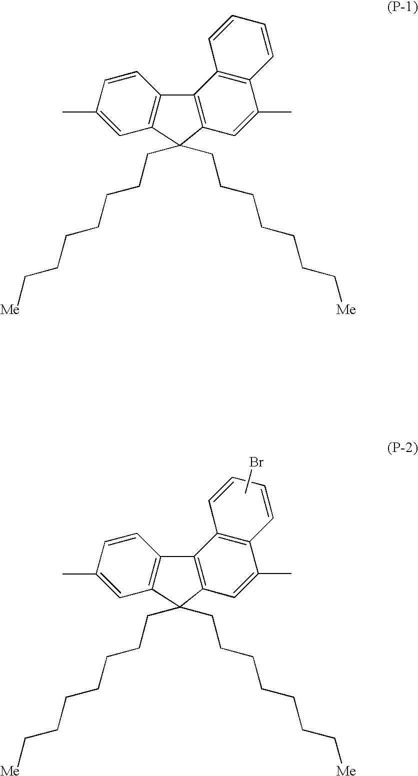

### SYNTHESIS EXAMPLE 4

### Synthesis of Compound G

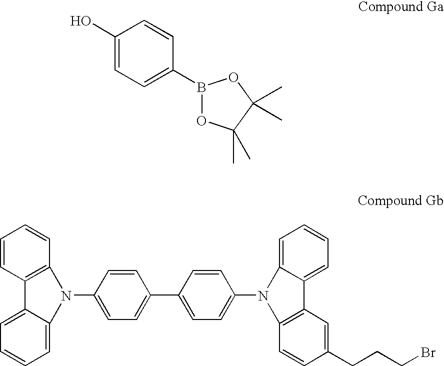

Under a nitrogen atmosphere, into a 50 ml three-necked flask was charged 1.32 g (6 mmol) of Compound Ga and 26.4 g of dehydrated dimethylformamide and stirred at room temperature to cause dissolution, then, cooled down to 0° C. Then, at 1 to 4° C., 0.29 g (7.2 mmol) of sodium hydride (content 60%) dispersed in a mineral oil was dropped over a period of 35 minutes and stirred for 2.5 hours at 1 to 2° C. Then, at 1.5 to 2.5° C., 2.42 g (4 mmol) of Compound Gb was divided into 5 portions which were charged over a period of 5 minutes. The mixture was stirred at 1.5 to 2° C. for 1 hour and at room temperature for 2 hours. Thereafter, 0.44 g (2 mmol) of Compound Ga and 0.15 g (3.8 mmol) of sodium hydride were additionally added at room temperature, and stirred for 1.5 hours at room temperature. Into a 300 ml three-necked flask was added 100 ml of water, and the reaction liquid was added slowly to this while stirring. This liquid was transferred to a 300 ml separating funnel and extracted three times with 100 ml of chloroform. The chloroform layer was transferred to a 500 ml separating funnel and washed three times with 100 ml of water. The chloroform layer was concentrated under reduced pressure at 75° C. using an evaporator to obtain 3.95 g of a concentrate. The concentrate was purified four times by silica gel chromatography {developing solvent: chloroform/n-hexane/triethylamine (1/1/0.002, volume ratio)} to obtain 1.64 g (yield: 55.0%) of Compound G as colorless solid.

¹H-NMR (270 MHz/CDCl₃):

δ1.33 (s, 12H), 2.23 to 2.26 (m, 2H), 3.00 to 3.05 (t, 2H), 4.03 to 4.08 (t, 2H), 6.91 to 6.95 (d, 2H), 7.28 to 7.35 (m, 4H), 7.42 to 7.53 (m, 7H), 7.68 to 7.78 (m, 6H), 7.89 to 7.93 (m, 4H), 7.99 to 8.11 (s, 1H), 8.13 to 8.19 (m, 3H)

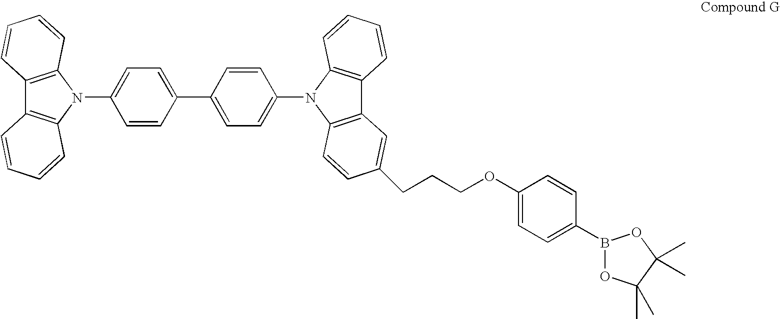

### EXAMPLE 1

### Synthesis of Polymer Compound 1

Polymer 2 (500 mg, 1.56 mmol in terms of benzofluorene repeating unit), Compound G (731 mg, 0.98 mmol), palladium (II) acetate (1.5 mg) and tricyclohexylphosphine (3.7 mg) were charged into a 100 ml flask, purged with an argon gas, then, 60 mL of commercially available dehydrated toluene was charged and the mixture was stirred at room temperature to cause dissolution. A tetraethylammonium hydroxide aqueous solution (1.4 mol/l, 2.4 ml) was charged and the temperature was raised to 110° C., then, the mixture was stirred for 3 hours at 110° C., then, 532 mg of 4-t-butyl-4,4,5,5-tetramethyl-[1,3,2]dioxaborolane-2-yl)benzene, palladium (II) acetate (0.4 mg), tricyclohexylphosphine (1.1 mg) and tetraethylammonium hydroxide aqueous solution (1.4 mol/L, 0.7 ml) were charged, and the mixture was stirred for 3 hours at 110° C. After cooling down to room temperature, the mixture was diluted with toluene, and washed with 15% saline, and the resultant organic layer was filtrated through celite, and concentrated under reduced pressure, and the concentrate was dropped into acetone to cause precipitation. The resultant the precipitate was filtrated, washed with acetone, and dried under reduced pressure to obtain 815 mg of a coarse polymer.

814 mg of the above-described coarse polymer was dissolved in 167 mL of toluene at room temperature, and the solution was passed through a silica gel column and alumina column through which toluene was previously passed through, and further, washed out by toluene, then, washed with a 3 wt % ammonia aqueous solution and water sequentially, and concentrated under reduced pressure to obtain 15 g of a solution. This was dropped into acetone, to cause re-precipitation. The precipitate was filtrated, washed with acetone, and dried under reduced pressure, thereby obtaining 794 mg of a polymer. The resultant polymer is called Polymer compound 1. The resultant Polymer compound 1 had a polystyrene-reduced number-average molecular weight Mn of 8.7×10⁴, a polystyrene-reduced weight-average molecular weight Mw of 1.7×10⁵, and a degree of dispersion Mw/Mn of 2.0.

From the results of element analysis, the ratio of a repeating unit (formula P-1), a repeating unit having a Br group (formula P-2) and a repeating unit having a side chain (P-3) corresponds to (P-1)/(P-2)/(P-3)=35/0/65, and the ratio of a benzofluorene repeating unit and a side chain corresponds to benzofluorene/side chain=61/39.

element analysis measured value: C 88.92%; H 7.57%; N 2.05%; Br <0.1%.

element analysis calculated value: C 89.06%; H 7.55%; N 2.16%; Br 0%. (calculated value at (P-1)/(P-2)/(P-3)=35/0/65)

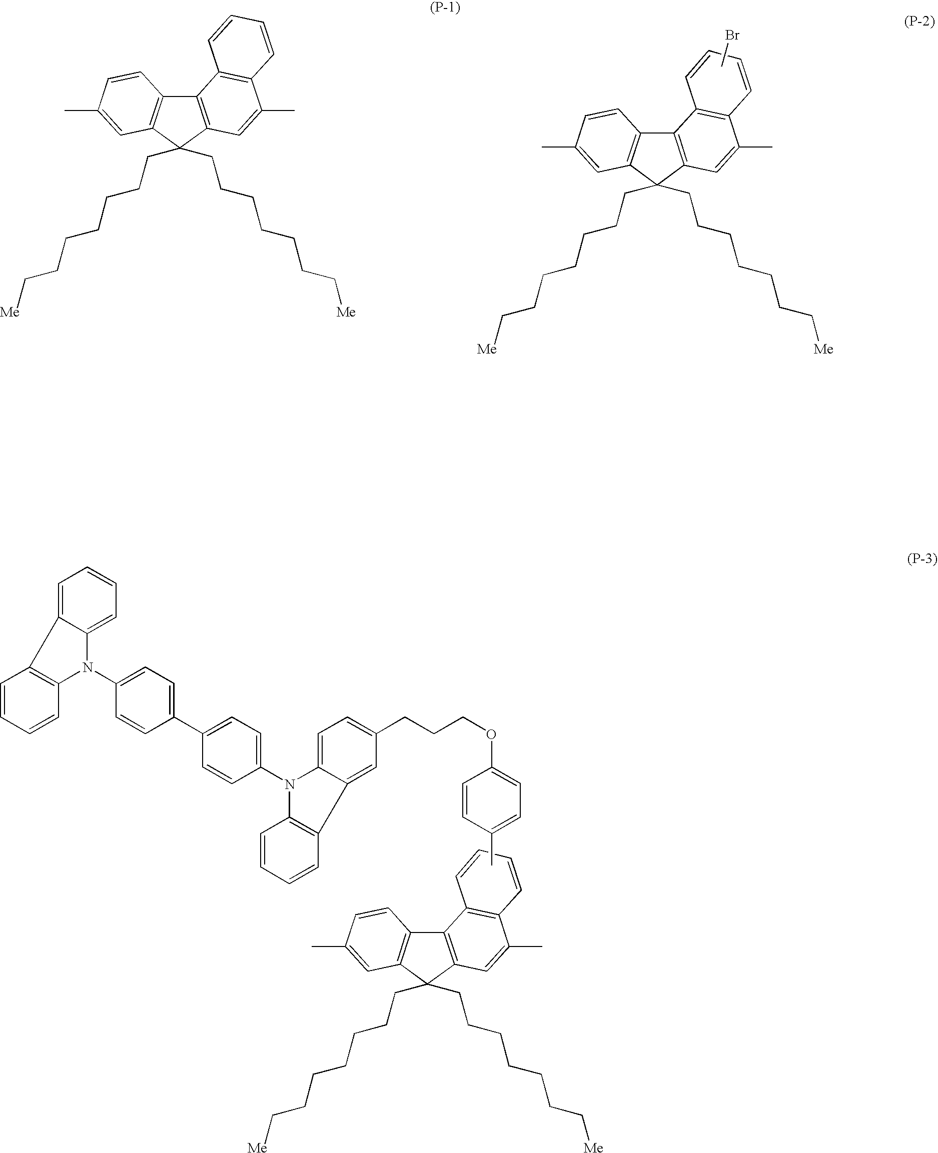

### SYNTHESIS EXAMPLE 5

### Synthesis of Compound H

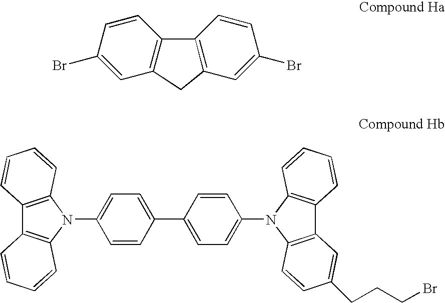

Under a nitrogen atmosphere, into a 50 ml three-necked flask was charged 14.3 g of 33% sodium hydroxide water, 0.65 g (2 mmol) of Compound Ha, 0.39 g (1.2 mmol) of tetra-n-butylammonium bromide and 6.5 g of toluene, and the temperature was raised to 45° C. At 45 to 50° C., 3.03 g (5 mmol) of Compound Hb was charged and the mixture was stirred at the same temperature for 4 hours. After stirring, the mixture was cooled down to room temperature, and the reaction liquid was transferred to a 300 ml separating funnel. 50 ml of toluene was charged, and the toluene layer was washed with 100 ml of water three times. The toluene layer was concentrated under reduced pressure at 75° C. using an evaporator to obtain 3.77 g of a concentrate. The concentrate was purified twice by silica gel chromatography {developing solvent: chloroform/n-hexane (1/1, volume ratio)} to obtain 2.42 g of pale red solid.

To this solid was added 30 g of chloroform, and the mixture was stirred under reflux for 0.5 hours. Subsequently, 45 g of n-hexane was added and the mixture was stirred under reflux for 0.5 hours. After cooling down to room temperature, the mixture was filtrated and the resultant cake was washed with 10 ml of n-hexane. This reflux stirring operation was repeated twice to obtain 2.06 g of pale yellowish red solid. This solid was purified by silica gel chromatography {developing solvent: chloroform/n-hexane (1/1, volume ratio)} to obtain 1.67 g of pale yellow solid. This solid was dissolved in 100 ml of chloroform at 50° C., and 1.7 g of activated carbon was added and the mixture was stirred for 1 hour at 50 to 45° C., and cooled down to room temperature, then, activated carbon was filtrated off. The filtrate was concentrated under reduced pressure at 75° C. using an evaporator to obtain 1.40 g (yield: 50.9%) of Compound H.

¹H-NMR (270 MHz/CDCl₃):

δ1.03 to 1.06 (m, 4H), 1.99 to 2.05 (m, 4H), 2.55 to 2.60 (t, 4H), 6.99 to 7.012 (d, 2H), 7.28 to 7.56 (m, 24H), 7.65 to 7.71 (m, 9H), 7.75 (s, 2H), 7.85 to 7.91 (m, 9H), 8.10 to 8.19 (m, 6H)

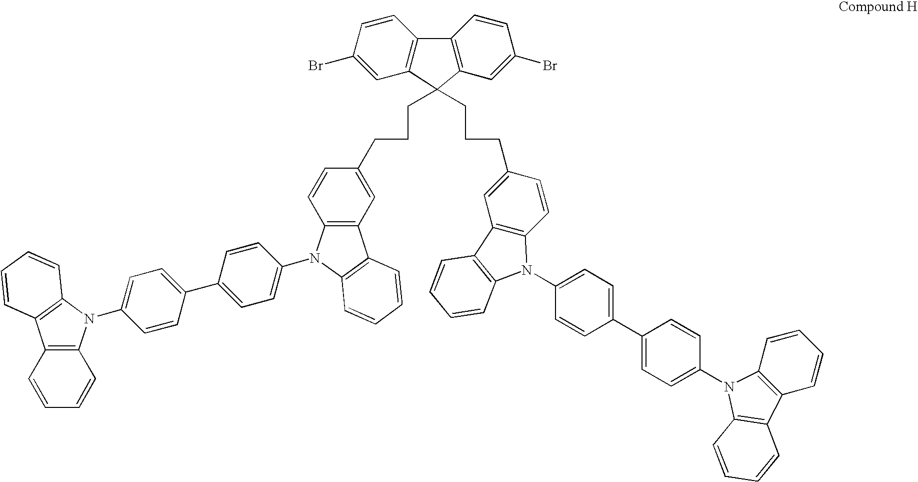

### EXAMPLE 2

### Synthesis of Polymer compound 2

Under an Ar gas atmosphere, in a 50 ml flask, 33 mg (0.06 mmol) of 9,9-dioctyl-2,7-dbromofluorene, 291 mg (0.24 mmol) of Compound H and 103 mg (0.66 mmol) of 2,2′-bipyridyl were dissolved in 23 ml of dehydrated tetrahydrofuran, then, the mixture was bubbled with an Ar gas for 15 minutes. The temperature was raised to 60° C., then, 182 mg (0.66 mmol) of bis(1,5-cyclooctadiene)nickel(0) {Ni(cod)₂} was added and the mixture was reacted by stirring for 3 hours. After reaction, this reaction liquid was cooled down to room temperature (about 25° C.), and dropped into a mixed solution of 25% ammonia water 5.5 g/methanol 22 g/distilled water 28 g to cause precipitation of the polymer. The resultant precipitate was filtrated, washed with methanol, and dried under reduced pressure, thereby obtaining 277 mg of a coarse polymer.

277 mg of the above-described coarse polymer was dissolved in 50 mL of tetrahydrofuran at 40° C., and filtrated using radiolite as a filtration aid, further, washed out with tetrahydrofuran, then, the solution was passed through a silica gel column and alumina column through which tetrahydrofuran was previously passed through, and further, washed out with tetrahydrofuran, then, concentrated under reduced pressure to obtain 10 g of a solution. This was dropped into methanol, to cause re-precipitation. The precipitate was filtrated, washed with methanol, and dried under reduced pressure, thereby obtaining 209 mg of a polymer. The resultant polymer is called Polymer compound 2. The resultant Polymer compound 2 had a polystyrene-reduced number-average molecular weight Mn of 6.8×10⁴, a polystyrene-reduced weight-average molecular weight Mw of 1.9×10⁵ and a degree of dispersion Mw/Mn of 2.8.

The ratio of repeating units (formula P-4) and (P-5) in the Polymer compound 2 estimated from the charged ratio is (P-4)/(P-5)=20/80.

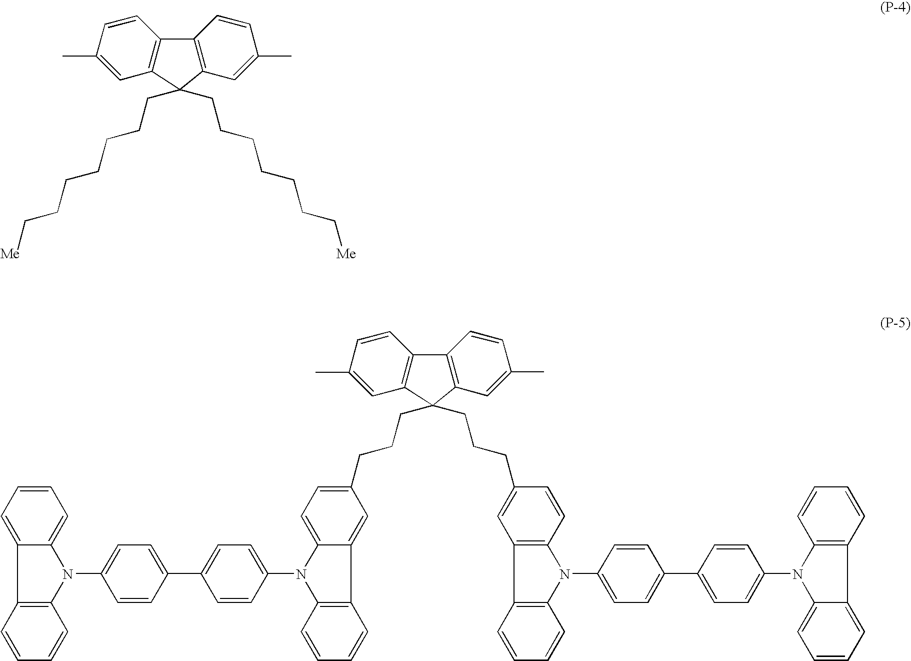

### <Value of HOMO Energy and LUMO Energy of Main Chain and Side Chain of Polymer Compounds 1 and 2>

### <Model Compound>

### [Polymer Compound 1 of Example 1]

The side chain of the polymer compound in Example 1 is as described above.

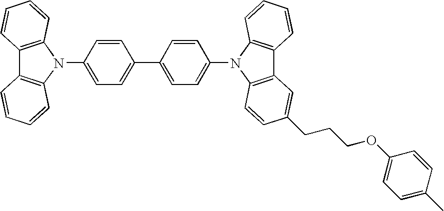

Therefore, the model compound of a side chain is a compound of the following formula.

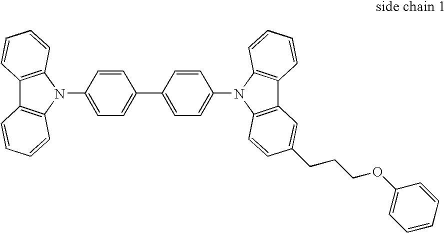

The polymer obtained by substitution of all side chains of the polymer compound in Example 1 with a hydrogen atom is a homopolymer having the following structure.

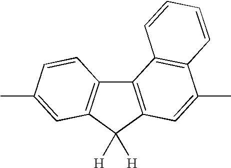

Therefore, the model compound of the conjugated polymer main chain is a compound of the following formula.

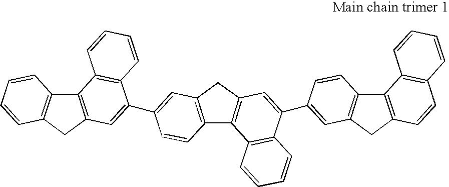

### [Polymer Compound 2 of Example 2]

The side chain of Polymer compound 2 in Example 2 is a side chain of the following formula.

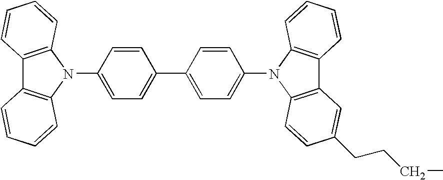

Therefore, the model compound of a side chain is a compound of the following formula.

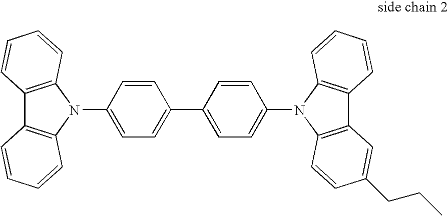

The polymer obtained by substitution of side chains of Polymer compound 2 in Example 2 with a hydrogen atom is a homopolymer having the following structure.

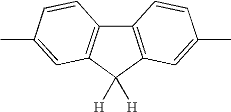

Therefore, the model compound of the conjugated polymer main chain is a compound of the following formula.

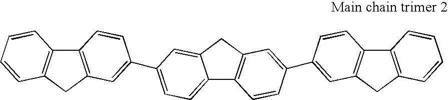

<Molecular Orbital Calculation>

For all of the above-described model compounds, a calculation for obtaining the most stable structure was carried out (calculation was repeated until reaching final convergence by key word: AM1 PRECISE EF) by AM1 method (Dewar, M. J. S. et al, J. Am. Chem. Soc., 107, 3902 (1985)) using a semi-empirical molecular orbital method MOPAC 2002 Version 1.00, thereby, the energy value and distribution of LUMO and HOMO of the main chain and side chain of Polymer compounds 1 and 2 could be obtained. The results are shown in table 1.

TABLE 1
molecular orbital calculation results

| | | | | | | | Absolute value of difference | |
|---|---|---|---|---|---|---|---|---|
| | | | | | | | in orbital energy between | |
| | Main chain | | | Side chain | | | main chain and side chain | |
| | | HOMO | LUMO | | HOMO | LUMO | ΔHOMO | ΔLUMO |
| | structure | (eV) | (eV) | structure | (eV) | (eV) | (eV) | (eV) |
| Polymer | Main | −8.06 | −0.94 | Side | −8.10 | −0.65 | 0.04 | 0.29 |
| compound 1 | chain | | | chain 1 | | | | |
| | trimer 1 | | | | | | | |
| Polymer | Main | −8.24 | −0.74 | Side | −8.06 | −0.62 | 0.18 | 0.12 |
| compound 2 | chain | | | chain 2 | | | | |
| | trimer 2 | | | | | | | |

### COMPARATIVE EXAMPLE 1

### Synthesis of Polymer Compound 3

22.5 g of Compound E and 17.6 g of 2,2′-bipyridyl were charged into a reaction vessel, then, the atmosphere in the reaction system was purged with a nitrogen gas. To this was added 1500 g of tetrahydrofuran (dehydrated solvent) previously deaerated by bubbling with an argon gas. Next, to this mixed solution was added 31 g of bis(1,5-cyclooctadiene)nickel(0) and the mixture was stirred at room temperature for 10 minutes, then, reacted at 60° C. for 3 hours. The reaction was carried out in a nitrogen gas atmosphere.

After the reaction, this reaction solution was cooled, then, into this solution, a mixed solution of 25% ammonia water 200 ml/methanol 900 ml/ion exchange water 900 ml was poured, and the mixture was stirred for about 1 hour. Next, the produced precipitate was filtrated and recovered. This precipitate was dried under reduced pressure, then, dissolved in toluene. This toluene solution was filtrated to remove insoluble materials, then, this toluene solution was purified by passing through a column filled with alumina. Next, this toluene solution was washed with 1 N hydrochloric acid aqueous solution, and allowed to stand still, and liquid-partitioned, then, the toluene solution was recovered. Next, this toluene solution was washed with ca 3% ammonia water, and allowed to stand still, and liquid-partitioned, then, the toluene solution was recovered. Next, this toluene solution was washed with ion exchange water, and allowed to stand still, and liquid-partitioned, then, the toluene solution was recovered. Next, this toluene solution was poured into methanol, to cause re-precipitation.

Next, the produced precipitate was recovered, and washed with methanol, then, this precipitate was dried under reduced pressure to obtain 6.0 g of a polymer. This polymer is called Polymer compound 2. The resultant Polymer compound 2 had a polystyrene-reduced weight-average molecular weight of 8.2×10⁵ and a polystyrene-reduced number-average molecular weight of 1.0×10⁵.

Polymer compound 3 is composed of a repeating unit (formula P-1).

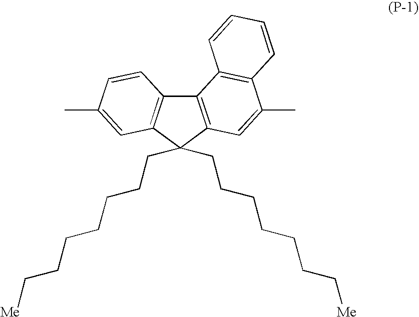

### COMPARATIVE EXAMPLE 2

### Synthesis of Polymer Compound 4

65.8 g of 2,7-dibromo-9,9-di-n-octylfluorene, 14.0 g of 2,7-dibromo-9,9-bis(2-methylbutyl)fluorine and 55.0 g of 2,2′-bipyridyl were dissolved in 400 mL of dehydrated tetrahydrofuran, then, the atmosphere in the system was purged with nitrogen by bubbling with nitrogen. Under a nitrogen atmosphere, to this solution was added bis(1,5-cyclooctadiene)nickel(0) {Ni(COD)₂} (101.16 g) and the mixture was heated up to 60° C. and reacted for 8 hours while stirring. After the reaction, this reaction liquid was cooled down to room temperature (about 25° C.), and dropped into a mixed solution of 25% ammonia water 3000 ml/methanol 3000 ml/ion exchange water 3000 ml, and the mixture was stirred for 0.5 hours, then, the deposited precipitate was filtrated and dried under reduced pressure for 2 hours, then, dissolved in 2775 mL of toluene before performing filtration, and to the filtrate was added toluene to give a solution of about 7000 mL, then, the organic layer was washed with 5000 ml of 1 N hydrochloric acid was for 1 hour, with 5500 ml of 4% ammonia water for 1 hour, with 2500 ml of ion exchange water for 10 minutes, further with 2500 ml of ion exchange water for 10 minutes. The organic layer was concentrated under reduced pressure at 50° C. until reaching 1481 g, then, dropped into 8300 ml of methanol and the mixture was stirred for 0.5 hours, and the deposited precipitate was filtrated, washed twice with 1250 mL of methanol, then, dried under reduced pressure at 50° C. for 5 hours. The resultant copolymer had a yield of 52.9 g. This copolymer is called Polymer compound 4. The polystyrene-reduced weight-average molecular weight Mw was 4.7×10⁵.

The ratio of repeating units (formula P-4) and (P-6) in Polymer compound 4 estimated from the charged ratio was (P-4)/(P-6)=80/20.

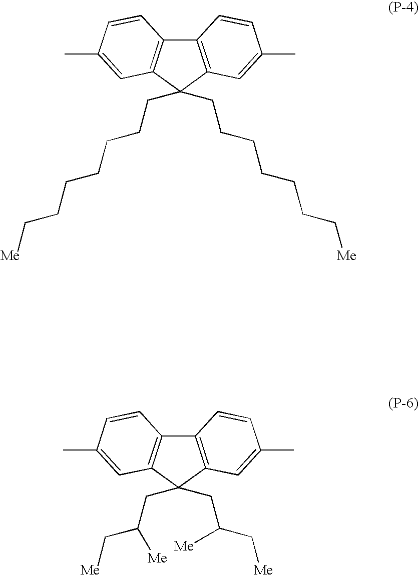

### SYNTHESIS EXAMPLE 6

### Synthesis of Polymer Compound 5

Under an inert atmosphere, N,N′-bis(4-bromophenyl)-N,N′-bis(4-n-butylphenyl)-1,4-phenylenediamine (1.911 g), N,N′-bis(4-bromophenyl)phenylamine (0.484 g) and 2,2′-bipyridyl (1.687 g) were dissolved in 109 mL of dehydrated tetrahydrofuran previously bubbled with argon. This solution was heated up to 60° C., then, bis(1,5-cyclooctadiene)nickel(0) {Ni(COD)₂} (2.971 g) was added and the mixture was stirred and reacted for 5 hours. This solution was cooled down to room temperature, and dropped into a mixed solution of 25% ammonia water 14 ml/methanol 109 ml/ion exchange water 109 ml and the mixture was stirred for 1 hours, then, the deposited precipitate was filtrated and dried under reduced pressure, and dissolved in 120 ml of toluene. After dissolution, 0.48 g of radiolite was added and the mixture was stirred for 30 minutes, and insoluble materials were filtrated. The resultant filtrate was purified by passing through an alumina column. Next, 236 mL of 4% ammonia water was added and the mixture was stirred for 2 hours, then, the aqueous layer was removed. Further, to the organic layer was added about 236 mL of ion exchange water and the mixture was stirred for 1 hour, then, the aqueous layer was removed. Thereafter, the organic layer was poured into 376 ml of methanol and the mixture was stirred for 0.5 hours, and the deposited precipitate was filtrated and dried under reduced pressure. The resultant polymer (hereinafter, called Polymer compound 5) showed a yield of 1.54 g. The polystyrene-reduced number-average molecular weight and weight-average molecular weight were Mn=7.4×10³ and Mw=7.6×10⁴, respectively.

### <Manufacturing of Hole Injection Layer>

Polymer compound 5 and a cross-linking agent DPHA (dipentaerythritol hexaacrylate) (KAYARAD DPHA manufactured by Nippon Kayaku Co., Ltd.) were mixed in toluene at a proportion of 80/20 to obtain dissolution thereof. Thereafter, the solution was filtrated through a filter of Teflon (registered trade mark) of 0.2 micron diameter to prepare a coating solution. On a glass plate carrying an ITO film formed by a sputtering method with a thickness of 150 nm, the above-described solution was spin-coated to form a film which was baked under a nitrogen atmosphere at 300° C./20 min to produce a hole injection layer. The thickness of the hole injection layer after baking was measured by a sensing pin type film thickness meter (DEKTAK manufactured by Veeco Instruments) to find a value of about 50 nm.

### <Preparation of Solution Composition for Light Emitting Layer>

The polymer compound was dissolved in a coating solution shown in Table 2. Thereafter, the solution was filtrated through a filter of Teflon (registered trade mark) of 0.2 micron diameter to prepare a coating solution.

### EXAMPLE 3

### Manufacturing and Evaluation of Device

On a hole injection layer, the polymer light emitter coating solution prepared was spin-coated to form a film having a thickness of about 70 nm. Further, this was dried under reduced pressure at 90° C. for 1 hour, then, lithium fluoride was vapor-deposited with a thickness of 4 nm as a cathode buffer layer, and calcium was vapor-deposited with a thickness of 5 nm, then, aluminum was vapor-deposited with a thickness of 100 nm as a cathode, manufacturing a polymer light emitting device. The degree of vacuum in vapor-deposition was always 1 to 9×10⁻⁵ Torr. By gradually applying voltage to the resultant device having a size of light emitting portion of 2 mm×2 mm (area: 4 mm²), the luminance of EL light emission from the polymer light emitter was measured, and the light emission efficiency value was obtained from this. The maximum value of light emission efficiency of the resultant device, and the maximum value of the PL fluorescence intensity thereof are shown in Table 2.

The lifetime test was carried out under driving at a constant current of 10 mA. The initial luminance and luminance half-life period are shown in Table 2.

As an index of balance between light emission efficiency and lifetime, the product of the maximum efficiency and luminance half-life period (item: efficiency×life) is shown in Table 2.

TABLE 2
device result view

| | | | Maximum light | | Life test | | |
|---|---|---|---|---|---|---|---|
| | | | emission | PL fluorescence | initial | luminance half- | |
| | polymer | | efficiency | intensity | luminance | life period | Efficiency × |
| | compound | Coating solvent | (cd/A) | (-) | (cd/m²) | (hr) | life |
| Example 1 | polymer | toluene | 7.28 | 17.9 | 11180 | 0.61 | 4.44 |
| | compound 1 | | | | | | |
| Comparative | polymer | toluene | 3.09 | 11.8 | 4380 | 0.31 | 0.96 |
| Example 1 | compound 3 | | | | | | |
| Example 2 | polymer | monochlorobenzene | 1.30 | 11.4 | 1788 | 1.2 | 1.56 |
| | compound 2 | | | | | | |
| Comparative | polymer | toluene | 2.19 | 7.4 | 3140 | 0.07 | 0.15 |
| Example 2 | compound 4 | | | | | | |

As shown in Table 2, when Polymer compounds 1 and 3, and Polymer compounds 2 and 4 are compared, respectively, it is understood that the device manufactured using the polymer compound of the example is a polymer light emitting device showing longer lifetime in the life test, and excellent also in balance between light emission efficiency and lifetime, as compared with the device using the polymer compound of the comparative example.

### INDUSTRIAL APPLICABILITY

If the polymer compound of the present invention is used as a material of a light emitting device, the lifetime and light emission efficiency of the light emitting device can be realized with excellent balance. Therefore, a polymer light emitting device containing the polymer compound of the present invention can be suitably used as a curved or plane light source for backlight or illumination of liquid crystal displays, and in apparatuses such as segment type displays, dot matrix type flat panel displays and the like.

1. A polymer compound having a conjugated polymer main chain and at least one side chain selected from the following (a), (b) and (c):
(a) side chain having electron transportability, wherein the value of LUMO energy of the side chain and the value of LUMO energy of the conjugated polymer main chain are mutually different, and the absolute value of the difference thereof is 0.3 eV or less,
(b) side chain having hole transportability; wherein the value of HOMO energy of the side chain and the value of HOMO energy of the conjugated polymer main chain are mutually different, and the absolute value of the difference thereof is 0.3 eV or less,
(c) side chain having electron transportability and hole transportability, wherein the value of LUMO energy of the side chain and the value of LUMO energy of the conjugated polymer main chain are mutually different, and the absolute value of the difference thereof is 0.3 eV or less, and the value of HOMO energy of the side chain and the value of HOMO energy of the conjugated polymer main chain are mutually different, and the absolute value of the difference thereof is 0.3 eV or less.

2. The polymer compound according to claim 1, having a side chain of said (a).

3. The polymer compound according to claim 1, having a side chain of said (b).

4. The polymer compound according to claim 1, having a side chain of said (c).

5. The polymer compound according to claim 1, wherein the side chain selected from said. (a), (b) and (c) is a compound residue having a connecting bond on at least one bonding site which has been bonded by a hydrogen atom of a compound of the following general formula (1), or a compound residue obtained by further connecting a group represented by -Z- to said residue: 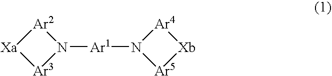
wherein, Ar¹ represents a C₆-C₂₆ arylene group, divalent C₃-C₂₀ hetero aromatic group, triphenylamine-4,4′-diyl group, or divalent aromatic group obtained by connecting two or more groups selected from these groups directly or via a divalent group represented by —N(Q¹)- (wherein, Q¹ represents a hydrogen atom, C₁-C₁₂ alkyl group, C₆-C₂₆ aryl group or C₃-C₂₀ hetero aryl group), Ar², Ar³, Ar⁴ and Ar⁵ represent each independently a C₆-C₂₆ arylene group or divalent C₃-C₂₀ hetero aromatic group, the Ar¹, Ar², Ar³, Ar⁴ and Ar⁵ optionally have a substituent, Xa represents an atom or atom group or a direct bond for forming a 6-membered ring together with Ar², Ar³ and nitrogen atom, Xb represents an atom or atom group or a direct bond for forming a 6-membered ring together with Ar⁴, Ar⁵ and nitrogen atom; and Z represents a divalent group.

6. The polymer compound according to claim 5, wherein the side chain selected from said (a), (b) and (c) is a group of the following general formula (2): 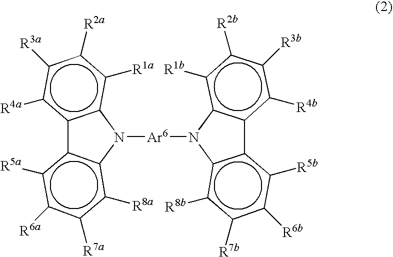
wherein, Ar⁶ represents a biphenyl-4,4′-diyl group, fluorene-2,7-diyl group, phenanthrene-3,8-diyl group, triphenylamine-4,4′-diyl group, or divalent group obtained by mutual connection of two or more groups selected independently from them; the Ar⁶ optionally has a substituent; R^{1a} to R^{8a} and R^{1b} to R^{8b} represent each independently a hydrogen atom, halogen atom, C₁-C₁₂ alkyl group, C₆-C₂₆ aryl group, C₃-C₂₀ hetero aryl group, C₁-C₁₂ alkyloxy group, C₆-C₂₆ aryloxy group, C₃-C₂₀ hetero aryloxy group, C₁-C₁₂ alkylthio group, C₆-C₂₆ arylthio group, C₃-C₂₀ hetero arylthio group, C₂-C₁₂ alkenyl group, C₂-C₁₂ alkynyl group, —NQ²Q³ (wherein, Q² and Q³ represent each independently a hydrogen atom, C₁-C₁₂ alkyl group, C₆-C₂₆ aryl group or C₃-C₂₀ hetero aryl group), —C≡N, —NO₂, connecting bond or group represented by -Z′- (wherein, Z′ is a linear, branched or cyclic C₁-C₂₀ alkylene group, C₆-C₂₆ arylene group, divalent C₃-C₂₀ hetero aromatic group, —O—, —S—, —C(═O)—, or divalent group obtained by combination of two or more groups selected from these groups; here, at least one of R^{1a} to R^{8a} and R^{1b} to R^{3b} is a connecting bond or a group represented by -Z′-.

7. The polymer compound according to claim 1, wherein a repeating unit of the following general formula (4) is contained in the conjugated polymer main chain: 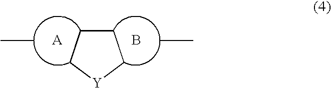
wherein, A ring and B ring represent each independently an aromatic hydrocarbon ring optionally having a substituent, two connecting bonds are present respectively on the A ring and B ring, and Y represents an atom or atom group forming a 5-membered ring or 6-membered ring together with two atoms on the A ring and two atoms. on the B ring.

8. The polymer compound according to claim 7, wherein the side chain selected from said (a), (b) and (c) is connected to a repeating unit of said general formula (4).

9. The polymer compound according to claim 7, wherein the repeating unit of said general formula (4) is a fluorenediyl group optionally having a substituent or a benzofluorenediyl group optionally having a substituent.

10. The polymer compound according to claim 5, wherein the content of a side chain of said general formula (1) in the polymer compound is 0.1 to 99 parts by weight with respect to 100 parts by weight of the whole polymer compound.

11. A conjugated polymer compound comprising a repeating unit represented by said general formula (4) and having a group of said general formula (2).

12. The polymer compound according to claim 9, wherein the repeating unit represented by said general formula (4) is a fluorenediyl group having a group of said general formula (2) or a benzofluorenediyl group having a group of said general formula (2).

13. The polymer compound according to claim 12, wherein the repeating unit represented by said general formula (4) is represented by the following general formula (U-01x), (U-05x), (U-11x) or (U-15x): 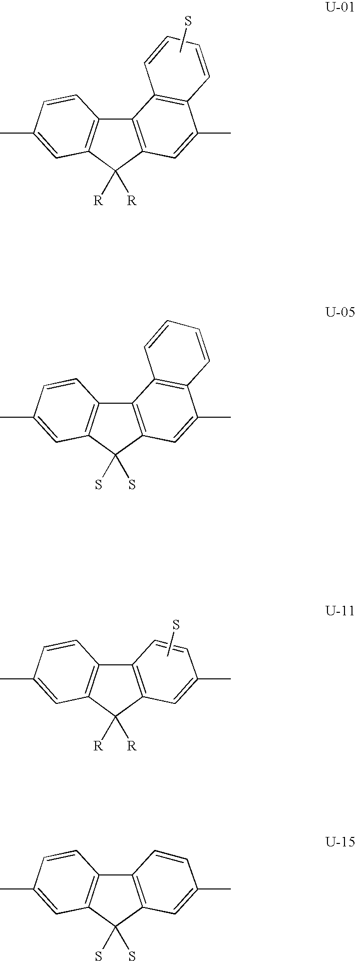
wherein, S represents a group of said general formula (2), and R represents a hydrogen atom, C₁-C₁₂ alkyl group, C₆-C₂₆ aryl group or C₃-C₂₀ hetero aryl group; a plurality of Rs and Ss may be mutually the same or different.

14. The polymer compound according to claim 6, wherein a divalent group represented by -Z′- in said general formula (2) is a linear, branched or cyclic C₁-C₂₀ alkylene group, C₆-C₂₀ arylene group, divalent C₃-C₂₀ hetero aromatic group, —O—, or divalent group obtained by combination of two or more groups selected from them.

15. The polymer compound according to claim 13, wherein the repeating unit represented by said general formula (4) is represented by any one of the following general formulae: 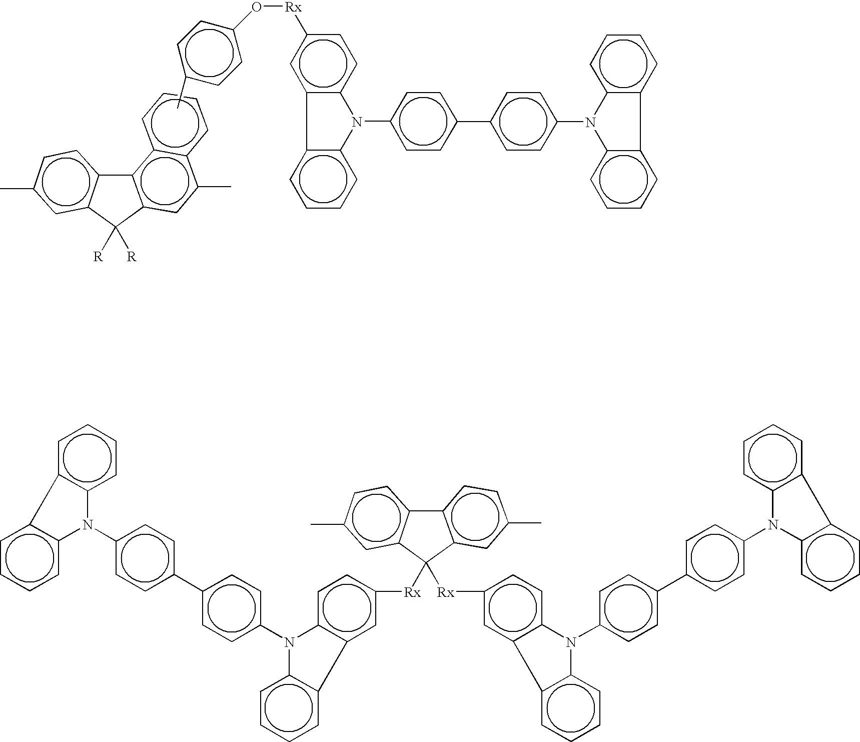
wherein, R represents the same meaning as described above, and Rx represents a linear, branched or cyclic C₁-C₂₀ alkylene group, C₆-C₂₆ arylene group, divalent C₃-C₂₀ hetero aromatic group or divalent group obtained by combination of two or more groups selected from them; and a plurality of Rxs may be the same or different.

16. The polymer compound according to claim 11, wherein the content of a repeating unit represented by said general formula (4) and having a group of said general formula (2) in the polymer compound is 0.1 to 100 parts by weight with respect to 100 parts by weight of the whole polymer compound.

17. The polymer compound according to claim 1, wherein the polystyrene-reduced number-average molecular weight is 10³ to 10⁸.

18. A solution comprising the polymer compound as described in claim 1 and a solvent.

19. A light emitting thin film comprising the polymer compound as described in claim 1.

20. An electric conductive thin film comprising the polymer compound as described in claim 1.

21. An organic semiconductor thin film comprising the polymer compound as described in claim 1.

22. A polymer light emitting device having a light emitting layer comprising the polymer compound as described in claim 1.

23. A sheet light source comprising the polymer light emitting device as described in claim 22.

24. A segment display comprising the polymer light emitting device as described in claim 22.

25. A dot matrix display comprising the polymer light emitting device as described in claim 22.

26. A liquid crystal display comprising the polymer light emitting device as described in claim 22.
